(19) United States
(12) Patent Application Publication
(10) Pub. No.: US 2009/0089145 A1
(43) Pub. Date: Apr. 2, 2009

(54) Freight transport logistics performance modeling software system and process

(76) Inventors: Paul Edward Kent, Fairfax Station, VA (US); Peter Dye Cook, Olympia, WA (US)

Correspondence Address: General Counsel, P.C., 6862 Elm Street, SUITE 800, McLean, VA, 22101, US

(21) Appl. No.: 11/906,016

(22) Filed: Sep. 28, 2007

(51) Int. Cl. G06Q 10/00; G06F 17/30; G06F 17/40

(52) U.S. Cl. 705/10

(57) ABSTRACT

A freight logistics efficiency modeling software embodied in a system and a process for implementing the software. The software interface allows an interactive, visual, user-defined freight transport supply model to be created at the instructions of the user. The model includes a seaport node, hinterland nodes, transportation links that represent transport pathways between nodes, and transportation transition nodes to represent discrete alterations of transport performance along transport pathways. The present invention allows a user to model logistics chain from a low level of abstraction, and to create highly effective theoretical alterations of existing models to examine proposed changes to an existing logistics chain. The use of existing standards allows completion of a model lacking complete data values, and further allows comparison of existing logistics chains to benchmark logistic chain performance and normal logistic chain performance.

### LICENSE RIGHTS

This invention was made with Government support under GS-10F0619N, Task Order EEM-M-00-06-000280-00 and PCE-I-00-98-00016-00, Task Order 13 awarded by the United States Agency for International Development. The Government has certain rights in the invention.

### FIELD OF THE INVENTION

The present invention relates to the field of analyzation of transport infrastructure and more specifically to the field of efficiency analysis in freight transport chains and subchains capable of being measured in terms of a recognizable unit of shipping.

### BACKGROUND

Logistics is difficult to define because it is both evolving and ubiquitous. It has evolved from a relatively straightforward concept of materials handling to a more expansive concept of a collection of services that facilitate the economic transactions associated with production and trade. As such, logistics encompasses not only the physical movement of goods (e.g., procurement, transport, consolidation, transshipment, storage, and packaging), but also the facilitation of this movement through processing of documents, coordination among participants, monitoring activities, and financing the overall transaction. Closely linked to movement and facilitation of movement is the concept of a supply chain, a combination of logistics services that delivers inputs from suppliers to the point of production (i.e., inbound) or delivers products from point of production to the marketplace and final consumer (i.e., outbound).

From a management viewpoint, logistics includes planning, implementing, and controlling the movement and storage of goods along the supply chain together with related services and information. To achieve efficiency it is necessary to integrate logistic services with marketing, and production scheduling. This is normally undertaken as part of supply chain management, which encompasses everything from sourcing and procurement of inputs through production/assembly of products, to sales and after-sales service.

An important distinction is that logistics concerns services, as distinct from infrastructure and other physical assets used to provide services. Initiatives for improving logistics may include modifications of physical assets with the goal of improving the quality of the services provided by those using these assets. Alternatively, initiatives may involve changes in the structure of the supply chains to reduce the number of transactions or better coordination between sequential activities in the chain. Finally, initiatives may involve improvements in complementary activities, in particular document processing.

Deciding which initiatives will be most beneficial requires understanding how initiatives affect service quality. This differs from the traditional approach of measuring the economic efficiency of individual transport and cargo handling activities. Two examples illustrate this difference: the first is an investment in additional road capacity; the second, an investment in freight berth and gantry cranes.

Widening a road link or constructing a new link will, by adding capacity, reduce congestion and average travel time thereby increasing the productivity of trucks and drivers. By improving the road surface, it reduces truck maintenance costs. The savings in operating costs that result can be estimated to provide a measure of the benefits from the investment. But from the shippers' perspective, the only benefits are those realized in the form of lower tariffs, which will depend on the level of competition in the trucking sector. The increase in average velocity and reduction in variance of travel time as a result of less congestion will cut inventory carrying costs provided that these are transmitted through the supply chain to reduce total transportation time. More significant benefits could be realized if the road improvements allow the logistics providers to operate newer, larger trucks on longer routes and to increase the number of trips per day on their shorter routes. Shippers would also benefit from safer transport for larger shipments and more frequent service.

Investing in freight berths and ship-to-shore gantry cranes provides faster turnaround of vessels at berth, which lowers berth occupancy and reduces vessel waiting time. The benefits from this investment are calculated based on the estimate of average savings in ship time multiplied by the value of ship's time. But from the shippers' perspective, this benefit is realized only if it results in a reduction in freight rates. This rarely occurs quickly unless there is a congestion surcharge that is removed once congestion is eliminated. It will occur gradually, assuming sufficient competition. The shipper may realize a significant benefit if shorter port time translates into shorter transportation time, but this is unlikely as most voyage patterns are designed to achieve day-of-the-week service at ports of call. However, substantial benefits could accrue if the reduction in turnaround time and congestion allows the shipping lines to convert from an unscheduled or loosely scheduled service to a day-of-the week schedule.

Because of the diversity of logistics services, an evaluation of the sector can be a complex undertaking. Evaluations tend to lose meaning as the scope is enlarged beyond few, key parameters. It is also important to organize the evaluation to proceed from general measures of performance to common logistics problems. From there it is possible to identify the sources of these problems and to develop strategies that address these problems. Well-conducted interviews best serve to identify and prioritize problems to be addressed.

Both the impact of changes in specific logistics activities and the overall effectiveness of supply chains can be measured using the same quality of service measures as shippers and consignees use to determine the competitiveness of the underlying trade in goods. These include, aside from cost and quality of production, time and cost for delivery. Inherent in the key measures is factor of reliability. Some common terms used for these measures are: total delivered cost, i.e. cost of good delivered to the buyer including that for logistics; order cycle time, i.e. the time from placing initial order to receipt of the goods ordered; and order fulfillment, i.e. probability of receipt of the goods in the correct amount, in good condition in accordance with the agreed delivery schedule.

The measurement of cost is generally stated as the total unit cost (i.e. the total cost for the delivered goods divided by the quantity of goods shipped). This may be specified as a percentage of the selling price for the goods at either the origin or the destination (e.g., 10% of FOB value) or as a cost per unit of weight, volume, or cargo unit (e.g., US$ per TEU, truckload, or wagonload).

The measurement of time is the average times for delivery of: inputs from suppliers to a production/assembly process; outputs from this process to the market; parts and after-sales technical support to the buyers. This may be the gross time between initiating and completing the shipment or the net time to complete the shipment after subtracting the time for discretionary activities (e.g., intermediate storage or delays requested by the buyer or the seller).

The measurement of reliability is more complex but can be expressed as a range (e.g., +two days, +10%, maximum 10 days−minimum six days), a standard deviation/coefficient of variance, or a confidence limit (e.g., 10 days or less for 95% of the shipments).

A reduction in time or cost for delivery or an increase in reliability in meeting delivery schedules will benefit all shippers. However, the value of these benefits to individual shippers will depend on the relative importance related to cost, time, and reliability. This value, in turn, varies with the type of goods and the markets in which they are sold. For high-value goods and dynamic markets, there will be a premium on the order time. For inputs to a continuous production activity, the greatest concern will be reliability of delivery, whereas for the goods produced, the principal concern is likely to be the delivered cost. Even individual shippers will have different priorities depending on the items shipped and to the markets to which they are shipped. Because of these differences, it is important that the logistics sector offer different combinations of cost, time, and reliability to meet the requirements of different shippers.

The four characteristics that affect the quality of logistics services are efficiency, competition, complexity, and compatibility. The first problem is the basic problem that confronts any productive activity: inefficient use of individual resources or mix of resources. For logistics, the resources are the physical assets and labor used to transport, store, consolidate, and package goods and to perform other value-added activities in the supply chain. Inefficient use of these resources reduces productivity and throughput and may cause congestion. The result is not only higher costs and longer transportation times but also greater variance in both.

The second problem is related: insufficient competition. Lack of competition contributes to the inefficient use of resources thus increasing cost and transportation time. It also reduces the likelihood that any gains in efficiency will be passed on to users. Finally, it limits the range of services offered and the variety of offerings in terms of cost, time, and reliability.

The third problem concerns the complexity of supply chains. Complexity is measured by number of transactions required to move goods through the supply chain and the number actors involved in this movement. The greater the number of transactions the more time and cost incurred—and so the greater the number of actors, the less reliability. Greater complexity occurs where there is a limit on competition or conversely on vertical integration.

The fourth problem concerns compatibility and is particularly important at the interfaces between activities. To construct an effective supply chain, it is necessary to coordinate sequential logistics services in terms of timing and capacity. This requires that: the time between the end of one activity and the start of the next be kept to a minimum; shipments remain intact when transferred from one activity to the other, or if they must be reconfigured, reconfigured with minimum cost and time for onward movement; and the information on the goods shipped be transferred at the same time and information on their status remain timely throughout the chain.

Interfaces can be seamless but are usually disruptive either because of a mismatch in throughput or capacity or because of the time required to transfer goods from one activity to another. This disruption adds time and cost but more importantly increases the uncertainty associated with time.

The quality of logistics services depends in part on the structure of the logistics industry and contractual arrangements for providing logistics services. The structure is defined by size of the enterprises and the degree of vertical concentration.

The size of the enterprises depends on the barriers to entry, extent of regulation, and level of demand. In the absence of heavy regulation, the logistics industry tends to be highly fragmented because of low barriers to entry for most services. This is most evident in trucking, warehousing, forwarding and clearance, which typically involve many relatively small, often informal, enterprises. Their size allows considerable flexibility. While they can provide efficient day-to-day operations, they are reluctant to invest in equipment or to introduce modern management techniques that would improve efficiency in the long term. In contrast, rail, ocean, and air transport enterprises tend to be large and formal because of greater barriers to entry and more intrusive regulation. But greater size is not a benefit unless competition stimulates investment and better management. In general, a mix of large and small-scale providers offers the best balance between economies of scale and competition. More important, it provides a greater variety in combinations of time, cost, and reliability.

Vertical integration refers not only to producers who provide their own logistics services but also to third-party logistics service providers who expand the range of services they offer. It can improve quality of service by increasing compatibility and reducing complexity. One of the most far-reaching changes in logistics management has been the transfer of responsibility from buyers' and sellers' shipping departments to third parties, commonly referred to as 3PLs. They provide basic logistics services but also act as brokers for logistics services (e.g., freight forwarders and NVOCCs). The increase in outsourcing was followed by expansion in range of services offered. The result was integrators, or 4PLs, who offer door-to-door logistics. They began as freight forwarders integrating transport and storage services and went on to develop international networks allowing them to arrange for a complete overseas movement. They then introduced value-added businesses such as managing inventories, beginning with intermediate storage and expanding to manage the goods from the time they are produced to the time they are sold.

The effectiveness of the contractual relations between shippers and logistics service providers and among logistics service providers is an important determinant of the quality of service. Because of the small size of most providers and their reluctance to make substantial investments in fixed assets, they often operate in a spot market or through brokers. While this provides flexibility and promotes competition, it also increases complexity and unreliability. Subcontracting has become an essential mechanism for providing integrated services. It allows 4PLs to focus on management and coordination while contracting out for the individual logistics services. The introduction of multimodal contracts of affreightment for domestic shipments and combined bills of lading for international shipments has allowed 4PLs to reduce the complexity of supply chains and increase compatibility within these chains. These contracts also provide a better allocation of liabilities for delays and losses thereby improving reliability.

Given the range of activities encompassed by logistics, the variety of problems that can affect the quality of services is immense. For the purposes of identifying and evaluating these problems, it is necessary to group them into categories according to their source. The primary sources identified for this purpose are as follows: physical operations and assets used in the transport, handling, and storage of goods; transactions related to these operations that occur between shippers and logistics service providers as well as among third parties involved in a supply chain; government policy that regulates these operations and the underlying trade; ancillary services such as financing and communications that contribute to the efficiency of these operations.

The principal source of problems, and the area most frequently analyzed, is the physical assets used for the transport, handling, and storage of goods moving through a supply chain. These assets are subdivided into infrastructure, equipment, and labor. Problems with the condition and capacity of infrastructure and equipment limit the throughput of these activities thereby increasing cost and time and reducing reliability. These problems are usually addressed by renewing existing assets or procuring new assets. Problems with labor, which are frequently more serious, affect not only time and costs but also the productivity of existing as well as new infrastructure and equipment. These problems are addressed by reducing the labor force and enhancing skills.

An equally important problem affecting the use of the assets is management performance. Logistics service providers normally evolve from individual operators to small enterprises providing a single service (e.g. cargo clearance, truck transport, warehousing). Their planning, monitoring, and communications are rudimentary and they rarely provide complementary value-added services. As these enterprises grow, they may make small improvements in management capacity, but significant improvements do not occur until they interact with international logistics companies with modern management practices, including specialization and delegation. This enhancement can be accomplished through a correspondent or agency arrangement, a joint venture or direct competition where there is significant technology transfer.

Because supply chains are usually constructed from a number of separate logistics activities, the movement of goods through a supply chain requires a number of commercial transactions between logistics service providers and/or between them and the cargo owners. A large percentage of logistics problems are caused by difficulties with these transactions as they add costs, delays, and uncertainty to the movement of goods through the supply chain.

Another set of transactions that frequently cause problems are those between shippers or logistics providers and the public officials whose approvals are required to move goods through the supply chain. While transactions involving public officials are usually minimal for domestic trade, they can be problematic within the country where provincial governments regulate the movement of goods transiting their province. For international trade they have traditionally been identified as a major source of cost and delay.

These transactions can be distinguished between those that must be completed prior to an activity taking place and those which occur as part of an activity. For example, a customs declaration must be submitted prior to clearance of import cargo and a contract of affreightment prior to transport of cargo but the bill of lading is issued after the cargo is loaded and transferred to the consignee while the vessel is enroute. The more complex the supply chain, the greater the number of transactions and their associated costs and delays. The more complex these transactions, the greater the cost and delays incurred.

Two of the most effective mechanisms for reducing the cost and delays associated with these transactions have been to simplify the documentation and to eliminate redundant requests for information. For this purpose, forwarders have introduced combined bills of lading; customs officials have introduced Single Administrative Documents, and trucking organizations have acquired TIR carnets.

Efforts to simplify transactions allow for greater integration of logistics services but require a suitable environment. The government must reduce paperwork and the number of signatures required while reforming inefficient and corrupt practices. The private sector should strive to adopt modern business practices, including increased transparency, enhanced specialization of management functions, delegation of authority, and investment in information communication technology.

A third mechanism has been to automate data processing. Although some aspects of detailing movement through a supply chain are deemed established, the use of this data drawn therefrom to facilitate that movement is still evolving. Track and trace systems are a standard offering by the larger logistics service providers, especially those operating internationally, but are only now being offered by smaller providers. Similarly, while most forwarders offer warehousing only the international service providers and some large domestic providers offer inventory management systems. The ability to embed logistics information systems into the enterprise software of clients has become an important value-added service but relatively few 4PLs have this capability.

The effect of government policies on logistics has received more attention because of the substantial economic benefits of deregulation and privatization. Economic regulations have created significant problems for logistics activities when they prevented pricing from adjusting to market conditions and when they increased barriers to entry for new providers entering existing markets and existing logistics providers entering new markets. These not only increased costs but also reduced the variety of time and cost combinations offered by 3PLs. Safety and environmental regulations have also increased operating costs but often provided compensating public benefits. However, they can cause problems for logistics service providers when they are enforced in an arbitrary or selective manner. The resulting loss of transparency discourages competition, thereby severely reducing any benefits that the regulation might have provided. These problems can be addressed through programs of reform and deregulation.

Regulation of international trade can also add time and costs to logistics activities. The imposition of duties and taxes on traded goods, restrictions on the types of goods traded (based on trade agreements and protection of domestic industries), and enforcement of safety, sanitary and phytosanitary standards increases the time and cost of moving goods across land borders or through international gateways, can be justified on political and economic grounds. Problems arise where these is a lack of diligence, consistency and transparency in enforcement of these regulations or where the procedures are inefficient thus introducing unnecessary costs, delays and uncertainty.

Another area of government policy that affects performance in the logistics sector is investment in public transport infrastructure assets. The role of the private sector in these investments has been the subject of considerable experimentation over the last two decades. This has led to an increase in the number of privately operated toll roads and rail track as well as port and airport terminal concessions. There are various models for allocating responsibility between the public and private sector but the principle criteria of success is whether they provide sufficient capacity in a timely manner, at reasonable cost, and with acceptable quality. Otherwise, they significantly increase the time and cost for the logistics activities that use this infrastructure.

A final area of government policy that affects logistics is taxation and subsidization. Excessive taxation of transport equipment can discourage investment while increasing transport costs. This problem is often cited with regard to imports of equipment, especially parts. Subsidization can be a problem especially when it is used to maintain inefficient transport services thereby lowering the returns to efficient transport or when it provides a competitive advantage to less efficient logistics service providers.

The remaining source of problems for the logistics sector are activities that facilitate logistics management, in particular, the acquisition of assets, the coordination of transactions and compliance with government regulations. Of particular concern is the lack of access to modern financial and communications services.

The role of the government in financing public infrastructure has already been discussed. Of equal importance is the availability of commercial financing for both capital investment and working capital. This is a significant problem for the logistics sector. In many countries, banks are reluctant to lend to transport service providers for the procurement of equipment unless the loan is securitized with property or other fixed assets. This has led to extensive use of leasing arrangements in some countries, but in others, it has left transport service providers dependent on savings of families and friends to acquire new equipment.

Logistics service providers who act as forwarders but do not own transport equipment or other significant fixed assets still a need working capital. The amount can be significant where transport companies and other logistics service providers require payment from forwarders on less favorable terms then the forwarders can obtain from the shippers. Producers and traders also require working capital. This is often financed against firm orders or buyers' Letters of Credit. Difficulties in obtaining this finance not only limit the amount of competition in the logistics sector but also prevent existing providers from expanding into new markets and increasing their market share.

The introduction of automatic debit systems has simplified transactions especially between logistics service providers and public agencies. These not only reduce the time required to complete transactions but improve transparency and eliminate the number of money exchanges between private parties and public officials.

Modem communications has been an essential part of logistics management. Email has replaced the telephone and fax as primary mode of communication, though internet-based transactions are usually limited either because electronic signatures are not legally recognized or because supporting financial services are not available.

Electronic data interchange (EDI) has also transformed transactions between the public and private logistics service providers. EDI allows supply chain participants to share information in a format that also supports data processing. While EDI has become essential in international transport and logistics, domestic providers have been slow to make the necessary investment. The public sector has often delayed the introduction of EDI because of difficulties in selecting a standard format (EDIFACT, XML/EDI, Rosetta.net, ebXML), method of access (VAN, VPN, or Internet), or, more commonly, right of access. Some government agencies have tried to discourage the use of EDI by restricting access, requiring hardcopy backup, and assigning strict liability for the data transmitted, but these actions are generally part of a broader effort to discourage transparency. At the same time, EDI has become essential for international trade and lack of it constitutes a competitive disadvantage.

The sources of problems discussed above can be linked to the general problems of inefficiency, competition, complexity, and compatibility. Problems with physical operations and assets generally result in inefficiency and incompatible interfaces. Problems due to excessive or complex transactions not only reduce efficiency but are symptomatic of complex supply chains. Difficulties associated with public regulation commonly lead to the complementary problems of inefficiency and lack of competition. Public policies related to international trade frequently lead to problems with compatibility at the borders and gateways. Limitations on ancillary activities constrain the growth of the logistics industry thereby maintaining the existing complexity of supply chains.

U.S. Pat. No. 6,486,899 purports to disclose a system for displaying logistics information using one or more computers via a presentation interface. The presentation interface generates a first panel displaying a plurality of icons and a plurality of links. The icons represent entities in a supply chain. Each link couples two of the icons and represents one or more distribution resources for moving one or more items between entities represented by the two icons. Each link indicates a distribution time associated with moving the items between the entities represented by the two icons. Each link may have a length proportional to the distribution time associated with moving the items between the entities represented by the two icons, or may include a time icon indicating the distribution time associated with moving the items between the entities represented by the two icons.

Although the '899 patent may simulate portions of a supply chain, the specificity by which the supply chain is presented prevents meaningful examination of a supply chain in certain low level aspects. For example, the links connect distribution resources and represent the totality of flow between the resources; the links do not, however, correlate to any particular means of transport. Although modeling the totality of logistics flow can have advantages, it lacks the capacity to model specific effects related to transport pathways, such as roads, rails, or waterways. It is highly advantageous in modeling logistics transport to include linkages between distribution centers that are specific and subject to their own inherent data, rather than used merely as a connection means between two entities comprising the data of the model.

Therefore, there is a need for a system that can more accurately model a freight transport and logistics system, including the port system, and the hinterland locations; record and store performance information for important logistics entities and the pathways leading to them; calculate performance information for the logistics chains and subchains; identify where the logistics system performs poorly in comparison with international standards; calculate the cost and time impacts of inefficiencies; help a user identify interventions that could mitigate constraints and reduce costs; calculate the impact on cost, time, and reliability of selected interventions; and assess cost and benefits (financial and economic feasibility) of investments needed to improve a freight transport logistics system.

### SUMMARY

The present invention is directed to a freight transport logistics performance modeling software embodied in a system and a process for implementing the software. The software interface allows an interactive, visual, user-defined freight transport logistics performance model to be created at the instructions of the user. The present invention is directed to the measurement and analysis of freight transport chains and subchains capable of being measured in terms of a recognizable unit of shipping (termed “freight” hereafter).

A preferred step in the process of the present invention includes establishing a freight logistics chain by logistically initializing both a seaport node and a hinterland node on a canvas. The freight logistics chain may then be subdivided on the canvas into one or more freight logistics subchains with at least one logistically initialized transport transition node. A preferred means for subdividing the freight logistics chain into freight logistics subchains includes the step of displaying a toolbar with a propagating transport transition node from which the user may select the transport transition node and displaying a propagating transportation link from which the user may select a transportation link. The nodes are graphically linked on the canvas with a logistically initialized transportation link. A freight transport performance value is calculated based on the logistical initializations between at least two of the nodes.

The logistic initializations of the present invention allow the user to enter data values related to the freight logistics performance of a node or a transportation link. Preferred values from which the seaport node and hinterland node are initialized include a freight processing indicator; a freight volume indicator; a utilized-freight indicator; and a freight commodity worth indicator. Logistic initializations may include either qualitative data of a freight transport performance level related to condition or freight transport efficiency (e.g. good, fair, poor or very poor), or quantitative data related to price, time, and reliability. The subjective data entries allow the present invention to reference a standard freight transport data value from a standards database.

Values from the standards database may be accessed to constitute all of the data values for the freight logistics proficiency of a node or transportation link, or the standards database may be used to supplement data values for the freight transport performance of a node or transportation link. The preferred standards database of the present invention includes two varieties of standards: benchmarks and norms. The benchmarks and norms are further categorized into multiple levels of data values corresponding to freight transport performance levels. For example, one level of standards data for benchmarks may relate to data values for good performance, while a second level of standards data for benchmarks may relate to data values for poor performance.

The freight performance values may be shown in any form amenable to allow efficient interpretation of data related to the freight transport performance model. The preferred results of the calculations are outputted to the user in the form of a graph. A further preferred step of the present invention compares freight transport efficiency from an existing logistics chain or subchain to a theoretical freight transport efficiency derived on proficiency values from the standards database.

The freight performance modeling software system of the present invention includes the canvas, a seaport logistics node initializer, a hinterland node logistics initializer, a transportation link logistics initializer, a transport transition node logistics initializer, the standards database, and a freight performance value calculator. The canvas is a dedicated section of a frame upon which graphic representations of entities and transportation links may be placed. It is preferred that a toolbar be placed proximate to the canvas upon which a transportation link propagator and a transportation transition node propagator may be accessed. Other embodiments may include a hinterland node propagator thereon.

The seaport node logistics initializer accepts for logistics initialization data values pertinent to the freight transport performance of a seaport. These values may include a seaport freight processing indicator; a seaport freight volume indicator; a seaport utilized-freight indicator; and a seaport freight commodity worth indicator. Upon receipt of logistics initialization values, the seaport node is displayed on the canvas.

The hinterland node logistics initializer accepts for logistics initialization data values pertinent to the freight transport performance of that particular hinterland node. These values may include a hinterland freight processing indicator; a hinterland freight volume indicator; a hinterland utilized-freight indicator; and a hinterland freight commodity worth indicator. Upon receipt of logistics initialization values, the hinterland node is displayed on the canvas. It is preferred that both the seaport node and the hinterland node be movably situated on the canvas.

The transportation link logistics initializer accepts data values related to a freight transport transit time and a freight transport price. The transportation link logistics initializer creates graphic linkages between nodes on the canvas. Each transportation link displayed represents a single transport pathway, e.g. a road, railway, etc., between two nodes.

The transport transition node logistics initializer accepts data values related to altering data values related to the freight transport rate and the freight transport price. It is preferred that the transportation transition node is placed on the canvas in an adjustable manner such that the node may be freely moved about the canvas, and any transportation linkages attached thereto would move therewith.

The freight logistics efficiency calculator is adapted to formulate freight transport performance values related to freight transport between at least two of the nodes. Other embodiments of the present invention may include a calculator further adapted to compare the freight transport performance values of an existing logistics supply chain or subchain to a theoretical freight transport performance value set derived from the standards data.

Therefore, it is an aspect of the present invention to provide modeling software capable of accurately measuring the performance of both existing and proposed freight logistic transport chains.

It is a further aspect of the present invention to provide modeling software capable of adjusting freight transport rate and freight transport price along a transport pathway due to many and varied circumstances.

It is a further aspect of the present invention to provide modeling software capable of representing a freight logistics transport chain and its constituent subchains.

It is a further aspect of the present invention to provide modeling software possessing freight transport standard data values.

It is a further aspect of the present invention to provide modeling software possessing freight transport standard data values of multiple levels of freight transport proficiency.

It is a further aspect of the present invention to provide modeling software capable of comparing existing and proposed freight logistic chains to theoretical freight logistic chains.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1a is a flowchart view of the process of the present invention.

FIG. 1b is a flowchart view of the process of the present invention.

FIG. 2 is a flowchart view of the process of the present invention.

FIG. 3 is a screenshot view of an embodiment of a scenario initializer of the system of the present invention.

FIG. 4 is a screenshot view of an embodiment of a scenario initializer of the system of the present invention.

FIG. 5 is a screenshot view of an embodiment of an established model of the system of the present invention.

FIG. 6 is a screenshot view of an embodiment of an established model of the system of the present invention with a placed transport transition node.

FIG. 7 is a screenshot view of an embodiment of an established model of the system of the present invention with a transportation link interconnecting two nodes.

FIG. 8 is a screenshot view of an embodiment of a developing model of the system of the present invention.

FIG. 9 is a screenshot view of an embodiment of the seaport node initializer of the system of the present invention.

FIG. 10 is a screenshot view of an embodiment of the seaport node initializer of the system of the present invention.

FIG. 11 is a screenshot view of an embodiment of the seaport node initializer of the system of the present invention.

FIG. 12 is a screenshot view of an embodiment of the hinterland node initializer of the system of the present invention.

FIG. 13 is a screenshot view of an embodiment of the hinterland node initializer of the system of the present invention.

FIG. 14 is a screenshot view of an embodiment of the transport transition node initializer of the system of the present invention.

FIG. 15 is a screenshot view of an embodiment of the transportation link initializer of the system of the present invention.

FIG. 16 is a screenshot view of an embodiment of the transportation link initializer of the system of the present invention.

FIG. 17 is a screenshot view of an embodiment of the transportation link initializer of the system of the present invention.

FIG. 18 is a screenshot view of an embodiment of the transportation link initializer of the system of the present invention.

FIG. 19 is a screenshot view of an embodiment of the transportation link initializer of the system of the present invention.

FIG. 20 is a screenshot view of an embodiment of the transportation link initializer of the system of the present invention.

FIG. 21 is a screenshot view of an embodiment of the transportation link initializer of the system of the present invention.

FIG. 22 is a screenshot view of an embodiment of the transportation link initializer of the system of the present invention.

FIG. 23 is a screenshot view of an embodiment of the transportation link initializer of the system of the present invention.

FIG. 24 is a screenshot view of an embodiment of the transportation link initializer of the system of the present invention.

FIG. 25 is a screenshot view of an embodiment of the transportation link initializer of the system of the present invention.

FIG. 26 is a screenshot view of an embodiment of the transportation link initializer of the system of the present invention.

FIG. 27 is a screenshot view of an embodiment of the transportation link initializer of the system of the present invention.

FIG. 28 is a screenshot view of an embodiment of the transportation link initializer of the system of the present invention.

FIG. 29 is a screenshot view of an embodiment of the transportation link initializer of the system of the present invention.

FIG. 30 is a screenshot view of an embodiment of an output of freight transport performance values of the system of the present invention.

FIG. 31 is a screenshot view of an embodiment of an output of freight transport performance values of the system of the present invention.

FIG. 32 is a screenshot view of an embodiment of an output of freight transport performance values of the system of the present invention.

FIG. 33 is a screenshot view of an embodiment of an output of freight transport performance values of the system of the present invention.

### DETAILED DESCRIPTION

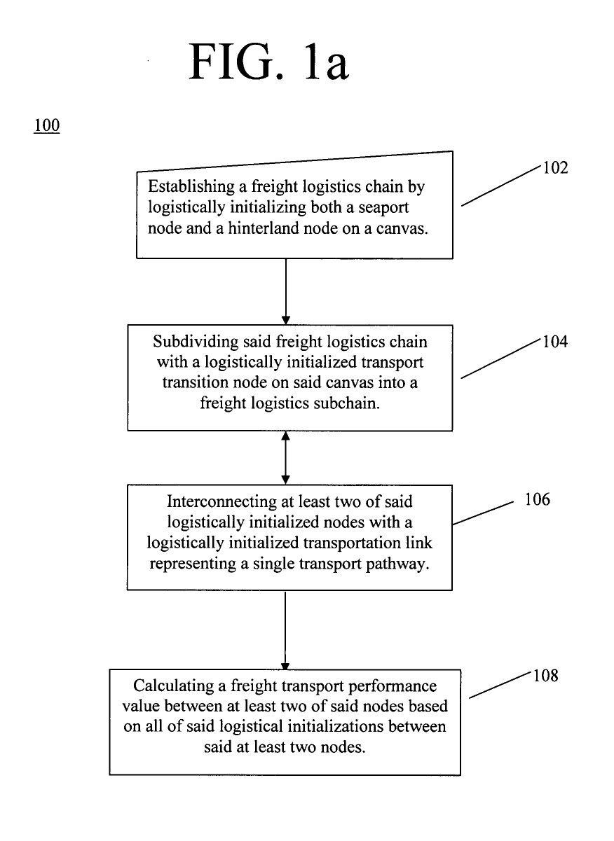

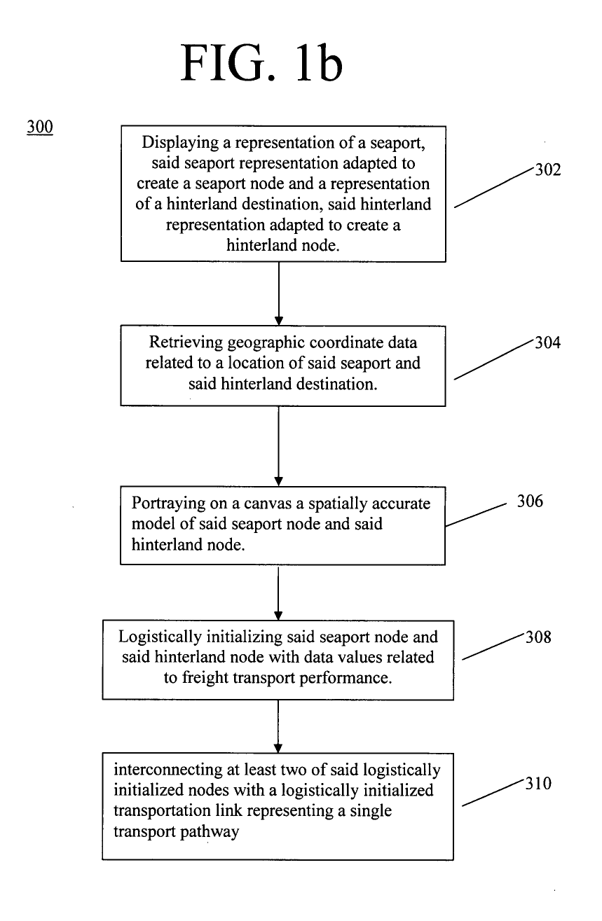

The present invention is directed to freight transport logistics performance modeling software embodied in a system and a process for implementing the software. Referring first to FIG. 1a, a basic embodiment of the software process 100 of the present invention is shown.

A user of the present invention begins with at least basic information of the freight logistics chain which s/he intends to model. The model of the supply chain is a succession of elementary links and nodes. Each link is characterized by the distance covered along the corridor, the average time spent, the variation in time and the fixed cost associated with the link and the mode of freight transport. A freight logistics chain model is established 102 by logistically initializing both a seaport node and a hinterland node on a canvas. The basic data values for this chain include the name of the seaport and the name of at least one origin-destination, i.e. hinterland, point at the ends of a freight logistics chain. Data relevant to freight logistics performance includes the annual freight flows for imports and/or exports and the percentage of freights carrying high, medium and low valued goods. This information is entered in the freight logistics initialization screen for the seaport definition.

An initializer of the present invention is used with any node or transportation link desired to be placed on the canvas, although the node or link may be initialized either before or after canvas placement. Initialization is when the node is imbued with a set of data values relating to freight transport performance values that are relevant to that particular entity or transportation link. These data values are static until altered by a user via later accessing the initializer. Because each node and link contains its own freestanding set of data independent of other nodes and links, the user is allowed great flexibility in adding later theoretical nodes and links to alter an existing model to seek logistics chain improvements. Each node (e.g. transport transition node) and transportation link has its own distinct initializer related to its function, and it is preferred that the nodes and links are further subdivided into specific nodes (e.g. rail node version of the transport transition node) and transportation links (e.g. railway) each with its own distinct initializer.

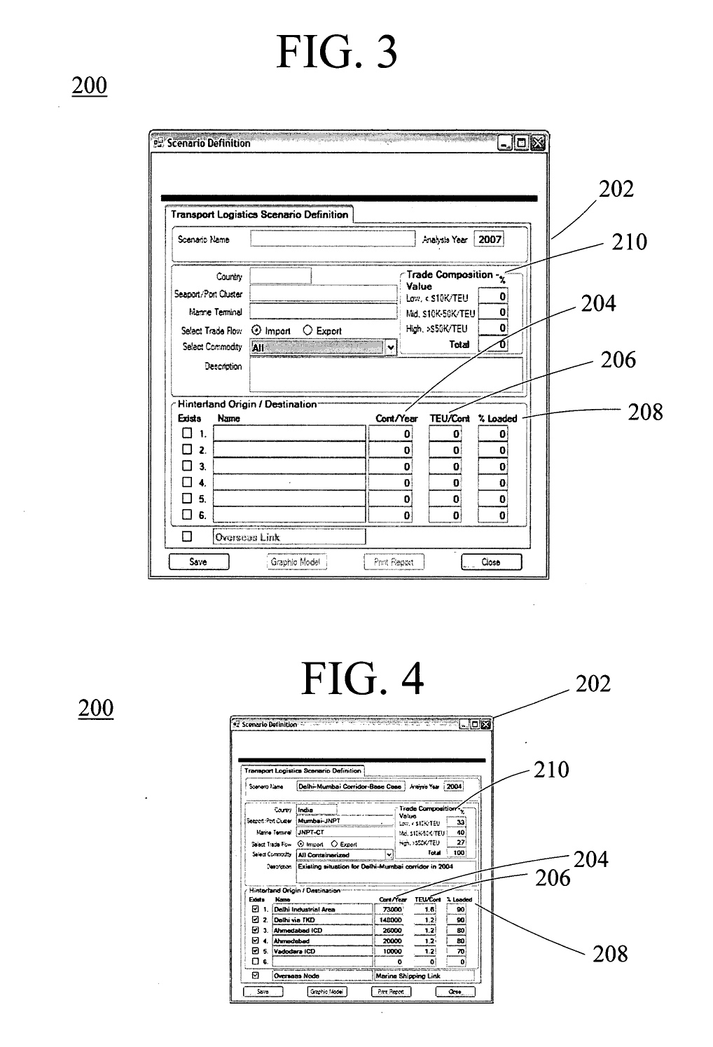

FIG. 3 illustrates a screenshot of the system 200 of the present invention with a preferred seaport node freight logistics initializer 202 allowing freight logistics initialization for a seaport node. It is preferred that the seaport node and all hinterland nodes be logistically initialized simultaneously; such a pairing of logistic initializations is termed scenario initialization in the remainder of this disclosure. Data values may include a scenario name, year, country, seaport or port cluster name, and the name of the marine terminal (i.e. freight terminal). The user may then select a trade flow (import or export) and a description of the scenario. A description is particularly helpful when creating a logistics model for the purpose of later establishing a theoretical model for comparison purposes.

It is preferred that all of the hinterland destinations be logistically initialized for freight performance simultaneous with initialization of the seaport, particularly in the same initialization—termed scenario initialization. The seaport freight logistics initializer preferably includes the name of each hinterland origin or destination that defines the logistics chain and its subchains. It is preferred to select separate hinterland points for each mode of transport. For example, if a road transport pathway and a rail transport pathway connect a city to the port, then the hinterland origin/destination should be listed once for each transport pathway, i.e. twice. A transport pathway of the present invention is a specific type of transportation link; while the term transportation link includes transportation from one node to another, transport pathway includes a single variety of transportation from one node to another. Lowering the level of abstraction from means for moving freight from point-to-point to a single means of moving freight from point-to-point allows the user greater flexibility in testing the efficiencies, both existing and potential, of a freight logistics transport scenario.

For each hinterland point for the traffic selected, import or export; a user preferably enters a freight processing indicator 204 representing the volume of freight (in transport units—e.g. tons or containers) per year; a freight shipment unit size indicator 206 representing a size average of the freight (e.g. TEUs per container or tons per pallet, etc.); a utilized-freight indicator 208 representing the percentage of loaded shipment units in that traffic flow; and finally a freight commodity worth indicator 210 estimating the percentage of low, medium, and high value commodities in the freights. The particular values deemed low, medium, and high—or other subdivisions of worth—may be altered depending on the circumstances of the model of the present invention; recommended values for low includes less than $10,000 USD, for medium between $10,000 USD and $50,000 USD, and for high greater than $50,000. This commodity worth indicator allows later calculations related to the economic importance of a freight logistics chain. The three percentages preferably equal to one hundred before the present invention allows a user to continue to a future step of the process. FIG. 4 depicts an example of a filled-in seaport freight logistics initializer 202 for the Delhi-Mumbai corridor in India.

Embodiments of the present invention may further utilize data related to an overseas entity linked logistically to the seaport. By selecting an overseas node and logistically initializing it, the present invention will automatically add an overseas link and node. This embodiment need not be used if the focus of the model is strictly on the in-country logistics chain and its performance.

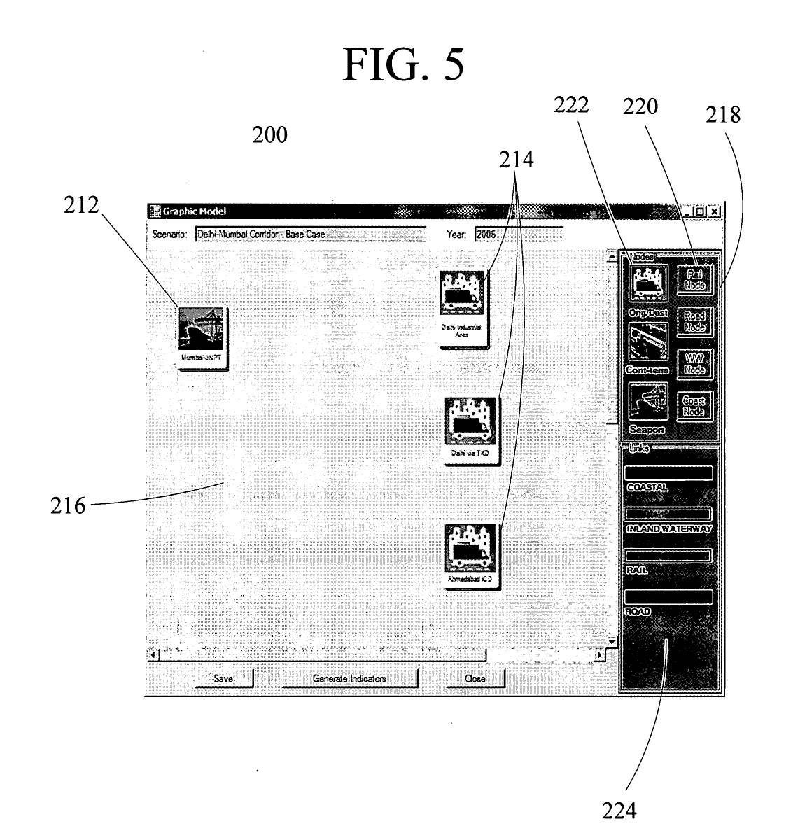

After the freight logistics initializations have been completed for the seaport node and hinterland node(s), as FIG. 5 shows, the seaport node 212 and hinterland nodes 214 are displayed on the canvas 216. The canvas 216 of the present invention includes a dedicated digital graphics display zone upon which the nodes and transportation links may be placed. The system 200 includes a toolbar 218 that displays editable portions of the system. Preferred members of the toolbar 218 include a hinterland node logistics propagator 222 adapted to propagate hinterland nodes 214; a transport transition node propagator 220 adapted to propagate a transport transition node (not shown); and a transportation link propagator 224 adapted to propagate a transportation link (not shown).

The propagator of the present invention includes an icon or other representation that when selected creates a graphic representation of the entity that the propagator represents. In the example of FIG. 5, the transportation transition node propagator includes graphic representations of four transportation nodes, and upon selecting one of the graphic representations with an input device, a transportation transition node is created to be positioned as desired on the canvas. A propagator of the present invention may include multiple graphic representations spawning graphic replicants, or simply include a single graphic representation from which a user tailors the physical characteristics to suit a particular entity or transportation link, or be some other representation (e.g. a word) from which graphic entities and transportation links are formed.

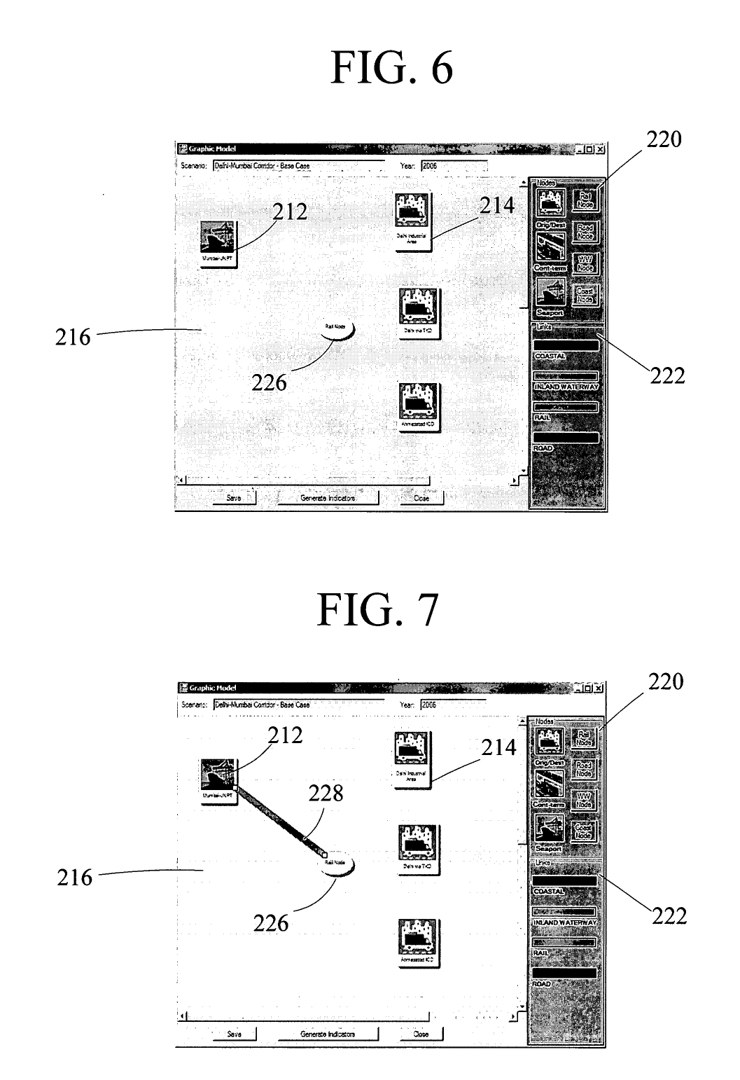

Turning now to FIG. 1A with reference to FIGS. 6 and 7, the transport transition node propagator 220 acts 104 to create transport transition nodes 226 which are nodes that subdivide the logistics chain into one or more subchains. It is preferred that any transport transition node 226 created from the transport transition node propagator 220 be capable of adjustable placement on the canvas 216. Adjustable placement allows the user to configure a logistics chain model in a manner s/he deems most convenient. The transportation link propagator 222 acts to create 106 transportation links 228 between any two nodes 212, 214, 226 on the canvas 216. It is preferred that transportation links 228 created from the propagating transportation link 222 allow the user to sketch in the direction of freight travel and “latch on” to a node, 212, 214, 226 so that movement of the node similarly moves any attached transportation links therewith.

Although initial adjustable placement is the preferred means of utilizing a propagator of the present invention, a geospatial embodiment of the present invention acts to automatically place nodes and transportation links on the canvas—although these initial placements may be later adjusted. The geospatial embodiment includes linkage to Geographic Information Systems (GIS) and geospatial data. GIS describes an information system that allows a user to input, store, manipulate and display geospatial data. It can include a range of functionality to assist the user in spatial analysis and may also include a system for programming of applications that combines GIS functions for a specific use. It can also be linked to other computer programs and database management systems. Geospatial data means data that is linked to a physical location on the earth's surface, through two or more map coordinates. This model of links and nodes characteristic of the many embodiments of the present invention, which are generally schematic in nature and therefore abstract from the physical locations of these transportation links and nodes would be replaced by a more accurate map-based graphic system. The map-based or geospatial data would be adopted from an existing digitized set of base data describing the freight transport model. The user would select the links in the geospatial data that represent the logistics chain to be used in transport performance value calculations. The user could combine these links to connect the selected nodes or could divide the links with transport transition nodes, where required. This process would use GIS functionality.

Turning to FIG. 1b a geographic information systems aided process 300 for creating an interactive, visual, user-defined freight transport model is shown. The process includes the step of displaying 302 a representation of a seaport and a hinterland destination/origin. The representation may be any device (e.g. icon, picture, or word) adapted to create the seaport node the hinterland node. Geographic coordinate data related to a location of said seaport and said hinterland destination is retrieved 304 in order to portray 306 on a canvas a spatially accurate model of the seaport node and the hinterland node. The user logistically initializes 308 the seaport node and the hinterland node with data values related to freight transport performance. At least two logistically initialized nodes are interconnecting 310 with a logistically initialized transportation link representing a single transport pathway.

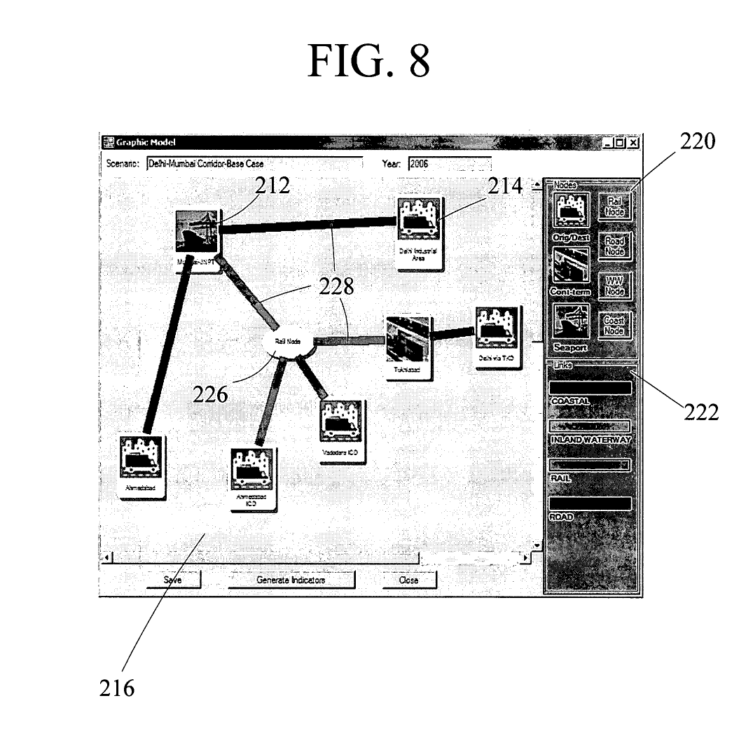

As a completed model shown in FIG. 8 depicts, transportation links 228 of the present invention represent a single transport pathway. Transport pathways include any pathway, and the vehicles operating thereon, that allows freight to move from one point to another. Examples of transport pathways of the present invention include coastal waterways, inland waterways, railways, and roads. Transport transition nodes 226 allow a user to more specifically define the interactions between a transport pathway and freight transport performance. A transport transition node represents any factor that may be encountered for freight en route via a transport pathway that affects either freight shipment price or freight shipment transit time. Data values of a transport transition node can reflect formal expenditures (e.g. tolls), informal payments (e.g. bribes), formal stoppages (e.g. immigration barriers), informal stoppages (e.g. entertainment zones), and the like that take place along the transportation link. Regarding a more strictly mathematical interpretation of transport transition node, the transport transition node should be used to separate transportation links which possess uniform data. The transport transition node may either be a “step up” transport transition node, which increases either the price or transit time of freight transport, or a “step down” transport transition node, which decreases either the price or transit time of freight transport. The transport transition nodes allow the flexibility to include such discrete inclines and declines in freight transport performance.

A primary use of a transport transition node 226 occurs when there are significant differences in price, time or reliability between two segments of a link. Both transportation links and transport transition pathways are initialized toward their respective functions by data relating to freight transport transit time, freight transport price, and freight transport reliability. More specifically, the transport transition node logistics initializer accepts inputs concerning performance indicators (e.g., price, time and reliability) as well as its name and the option to write a description of its characteristics. As the nodes and transportation linkages therebetween of the freight logistics model are arranged, it is preferred that the initializer for each entity is reactivated to include further data relating to freight transport performance. That is to say, initialization occurs when the node or transportation link is created and ends when all freight transport performance data pertinent to allowing a transport performance calculation is entered; placement of the node or transportation link may occur any time after creation, even to the extent that the initialization begins prior to placement of an entity or transportation link on the canvas and ends subsequent to placement. In some instances, it may be advantageous to place a node or transportation link on the canvas prior to the completion of initialization. Other embodiments of the present invention, however, may opt to initialize all entities at one time prior to placement.

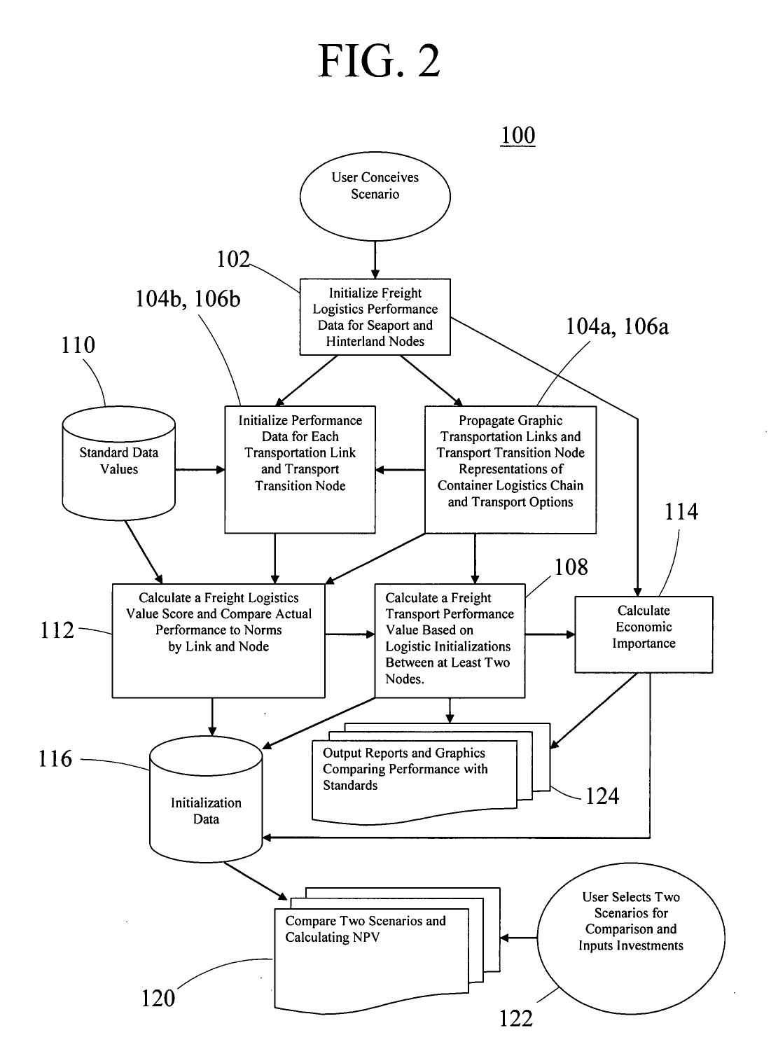

Although the present invention has been primarily described in terms of initializing nodes and transportation links prior to placing them on the canvas, as FIG. 2 shows, the links and nodes may be placed 104a, 106a on the canvas prior to finalizing initializing 104b, 106b the links and nodes.

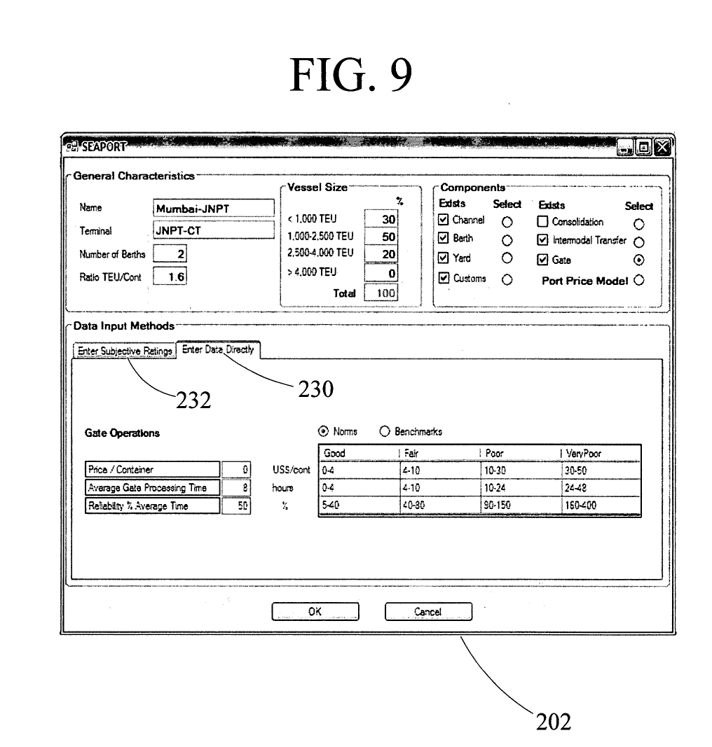

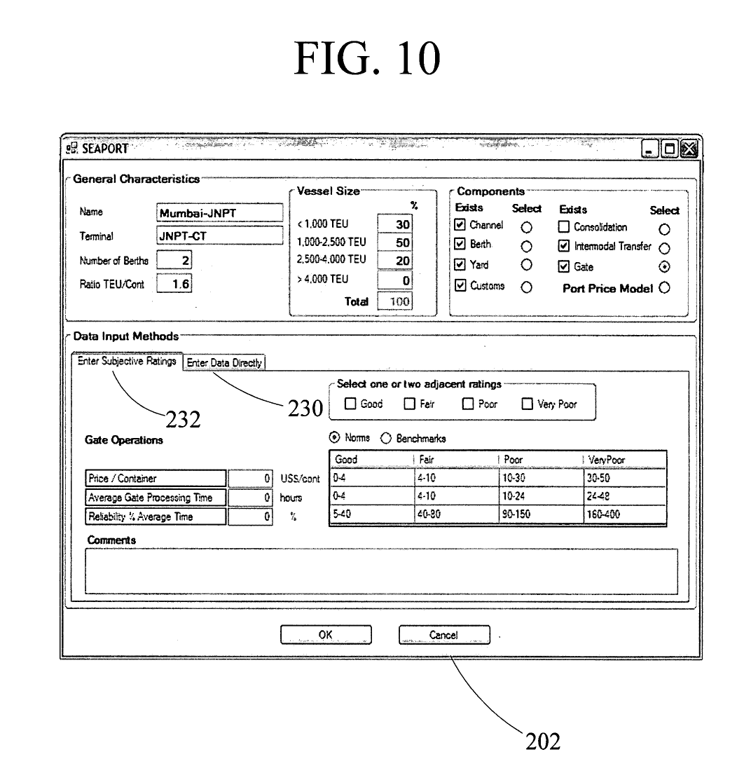

As FIG. 9 and FIG. 10 show, the seaport node freight logistics initializer 202 further prompts the user for performance data related to the freight logistics chain from the seaport node to each hinterland node. Data values for further freight logistics initialization include a percentage mix of freight vessel size serving the seaport (which should add to one hundred) and multiple seaport and terminal components. Other data values related to the logistical initialization of the seaport node and hinterland node may be accepted as quantitative direct data value submissions 230 or qualitative data submissions 232. In the quantitative data submissions, the user enters numerical data values related to freight transport performance. As quantitative values may not always be available, the present invention is adapted to accept qualitative data values relating to a level of freight transport performance. The levels of freight transport performance may be subdivided into as many levels as is deemed accurate by the provider of the modeling software. The qualitative submission, or submissions, is related to data values relating to the inputted level of freight transport proficiency, such that the user may specify a qualitative rating for which the present invention references a quantitative number derived from a standards database.

The preferred standards database of the present invention includes a set of data values for levels of freight transport performance for norms and benchmarks. A norm as used in this disclosure includes performance measures representing typical values in developing countries. It is further preferred that these measures are ordered in terms of good, fair, poor, and very poor. A benchmark as used in this disclosure includes performance measures representing best practice or typical developed country operations. Benchmarks are typical and best practice performance values for developed countries, USA, Europe, Japan and selected high performance countries such as Singapore. Benchmarks refer to excellent performance, and highly competent transportation operators may well try to match the benchmarks or to establish performance standards that are at least close to the international benchmarks. Benchmarks generally are developed for locations where freight transport proficiency is believed to be excellent. Benchmarks therefore provide a target regarding what is possible. Standard data values are inclusive of both benchmark data values and norm data values. Preferred standard transport proficiency data value categories are listed in Table 1.

TABLE 1

| ModeTypeID | ComponentTypeID | HandlingTypeID | NormName | NormUnitType |
|---|---|---|---|---|
| Coastal | | | PricePerTEU-Km | US$ |
| Shipping | | | | |
| Coastal | | | AvgSpeed | knots |
| Shipping | | | | |
| Coastal | | | AvgWaitTime | hours |
| Shipping | | | | |
| Coastal | | | Reliability | percent |
| Shipping | | | | |
| Inland | | | PricePerTEU-Km | US$ |
| Waterway | | | | |
| Inland | | | AvgSpeed | knots |
| Waterway | | | | |
| Inland | | | Reliability | percent |
| Waterway | | | | |
| Inland | | | AvgWaitTime | hours |
| Waterway | | | | |
| Rail | | | PricePerTEU-Km | US$ |
| Rail | | | AvgSpeed | kph |
| Rail | | | AvgWaitTime | hours |
| Rail | | | Reliability | percent |
| Road | | | PricePerTEU-Km | US$ |
| Road | | | AvgSpeed | kph |
| Road | | | AvgWaitTime | hours |
| Road | | | Reliability | percent |
| ICT | ICT-Consolidation | | ConsolidationRate | cont/hour |
| ICT | ICT-Consolidation | | ConsolidationPricePerCont | US$ |
| ICT | ICT-Consolidation | | ConsolidationTime | hours |
| ICT | ICT-Consolidation | | ConsolidationReliability | percent |
| ICT | ICT-Customs | | CustomsTime | hours |
| ICT | ICT-Customs | | CustomsPricePerCont | US$ |
| ICT | ICT-Customs | | CustomsReliability | percent |
| ICT | ICT-Customs | | CustomsTimePerCont | hours |
| ICT | ICT-Drayage | | DrayageReliability | percent |
| ICT | ICT-Drayage | | DrayageTime | hours |
| ICT | ICT-Drayage | | DrayagePricePerCont | US$ |
| ICT | ICT-Gate | | GateReliability | percent |
| ICT | ICT-Gate | | GateTime | hours |
| ICT | ICT-Gate | | GatePricePerCont | US$ |
| | ICT-Intermodal | | | |
| ICT | Transfer | | TransferReliability | percent |
| | ICT-Intermodal | | | |
| ICT | Transfer | | TransferTime | hours |
| | ICT-Intermodal | | | |
| ICT | Transfer | | TransferPricePerCont | US$ |
| ICT | ICT-Yard | | YardTime | hours |
| ICT | ICT-Yard | | YardReliability | percent |
| ICT | ICT-Yard | | StorageFeePerCont | US$ |
| ICT | ICT-Yard | | YardPricePerCont | US$ |
| Seaport | Seaport-Berth | 1 | BerthHandlingProductivity | moves/berth- |
| | | | | hour |
| Seaport | Seaport-Berth | 2 | BerthHandlingProductivity | moves/berth- |
| | | | | hour |
| Seaport | Seaport-Berth | | BerthPricePerCont | US$ |
| Seaport | Seaport-Berth | | BerthTimePerCont | hours |
| Seaport | Seaport-Berth | | BerthReliability | percent |
| Seaport | Seaport-Channel | | PortSurchargePerCont | US$ |
| Seaport | Seaport-Channel | | ChannelWaitTime | hours |
| Seaport | Seaport-Channel | | ChannelReliability | percent |
| Seaport | Seaport-Channel | | PilotPricePerCont | US$ |
| Seaport | Seaport-Consolidation | | Reliability | percent |
| Seaport | Seaport-Consolidation | | ConsolidationPricePerCont | US$ |
| Seaport | Seaport-Consolidation | | ConsolidationRate | cont/hour |
| Seaport | Seaport-Consolidation | | ConsolidationTime | hours |
| Seaport | Seaport-Customs | | Reliability | percent |
| Seaport | Seaport-Customs | | ProcessTime | hours |
| Seaport | Seaport-Customs | | StuffPricePerCont | US$ |
| Seaport | Seaport-Customs | 0 | CustomFeePerCont | US$ |
| Seaport | Seaport-Gate | | GatePricePerCont | US$ |
| Seaport | Seaport-Gate | | GateTime | hours |
| Seaport | Seaport-Gate | | GateReliability | percent |
| Seaport | Seaport-Transfer | | TransferTime | hours |
| | Facility | | | |
| Seaport | Seaport-Transfer | | TransferReliability | percent |
| | Facility | | | |
| Seaport | Seaport-Transfer | | TransferPricePerCont | US$ |
| | Facility | | | |
| Seaport | Seaport-Yard | 0 | YardTime | hours |
| Seaport | Seaport-Yard | | StorageFeePerCont | US$ |
| Seaport | Seaport-Yard | | YardReliability | percent |
| Seaport | Seaport-Yard | | HandlingFeePerCont | US$ |

The data values for the standards may be acquired via many publicly available sources, and as FIG. 2 shows, the standards 110 may by included into logistics initializations 104b, 106b of a seaport node, hinterland node, a transportation transition node, a transportation link, or the standards may be used as a comparison of an overall logistics performance resulting from a chain or subchain of the model. The standards may be used to supplement initializations, or to compare 112 models of existing logistic chains to theoretical models. It is a feature of the present invention to provide a data base electronically accessible via a data medium, e.g. the Internet, a network, or the like, from which the software of the present invention may automatically update to reflect changes in standards. An example set of standard data values for two qualitative ratings is shown in Table 2.

TABLE 2

| | | | | Good | | | Fair | | |
|---|---|---|---|---|---|---|---|---|---|
| No | Mode | Norm Name | Unit | min | mean | max | min | mean | max |
| 41 | Coastal | PricePerTEU-Km | US$ | 0.2 | 0.25 | 0.275 | 0.275 | 0.3 | 0.4 |
| | Shipping | | | | | | | | |
| 42 | Coastal | AvgSpeed | knots | 9 | 10 | 15 | 7 | 8 | 9 |
| | Shipping | | | | | | | | |
| 43 | Coastal | AvgWaitTime | hours | 1 | 4 | 6 | 6 | 8 | 12 |
| | Shipping | | | | | | | | |
| 44 | Coastal | Reliability | percent | 5 | 35 | 40 | 40 | 65 | 80 |
| | Shipping | | | | | | | | |

Both norms and benchmarks can be used as a means of evaluating local conditions or how well a particular logistics chain of a model measures up to international benchmarks in terms of cost, trip time, reliability, loss and damage or other matters affecting trade.

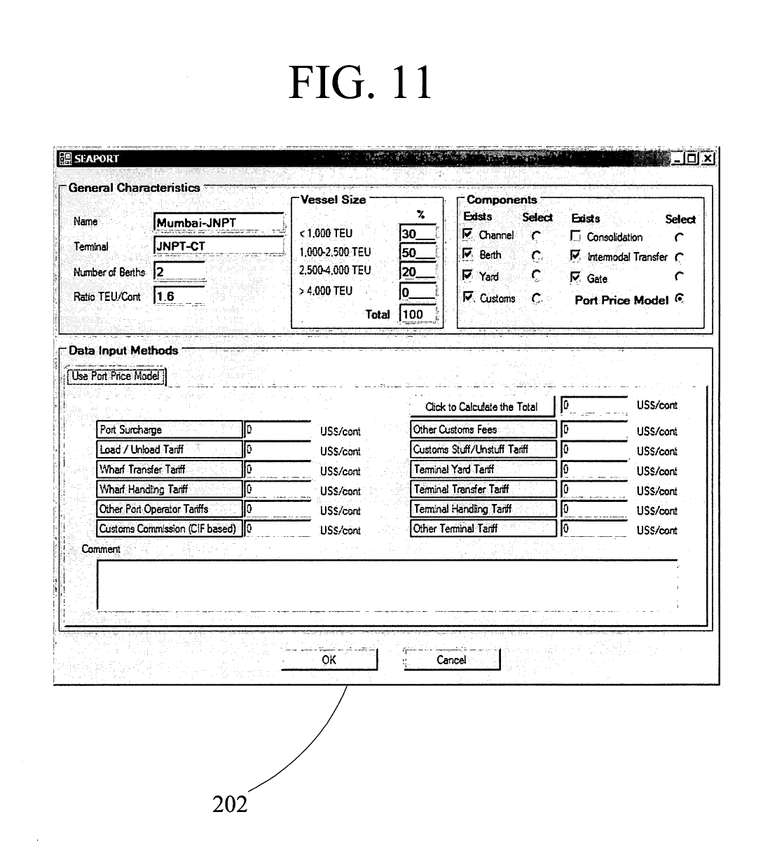

As FIG. 11 shows, the seaport node logistics initializer 202 may further elicit data value submissions for the seaport node and any hinterland nodes related to seaport pricing data related to freight logistics initialization. Seaport pricing data accounts for total port price per freight, which the present invention reallocates to the seaport node and hinterland node components.

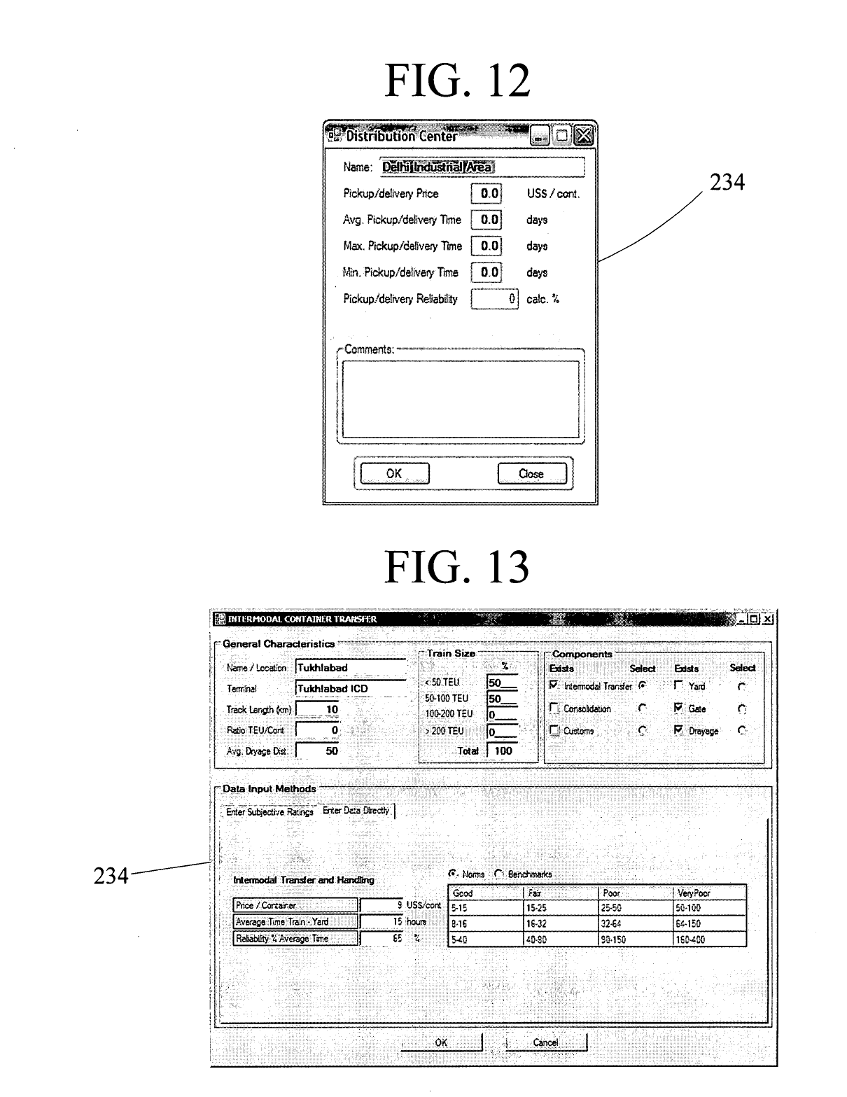

Although it is preferred that any hinterland node of the present invention is logistically initialized simultaneously with the seaport node in a scenario initialization, as FIG. 12 shows, a distinct hinterland logistics initializer 234 adapted to further logistically initialize the hinterland node may be utilized. The hinterland logistics initializer 234 elicits information such as price, time, and reliability data related to freight transport performance. The data input for price, time and reliability could reflect the activities required to get import and export documentation, for example. Although the present disclosure primarily discusses the hinterland node at the termination of a freight transport chain, the hinterland node may occupy an intermediate position between two transportation links that leads in turn to an additional hinterland node at the termination of the freight transport chain.

FIG. 13 shows a specialized hinterland node logistics initializer 234 for an Intermodal Freight Transfer (ICT) node. As an ICT may be generally equated to a land version of a seaport, the freight logistics initializations for an ICT are similar to those for seaport terminals. ICT nodes are used primarily for an interface between road and rail or an inland port terminal. However, they can also be used for coastal and IWW (Inland Waterway) terminals if there is an intermodal transfer to the road or rail transportation link.

The ICT logistics initializer 234 requests general information related to freight transport performance and a set of percentages, which in the example of FIG. 13 represent train sizes in this case—though they could also be barge or ship sizes in the case of IWW or coastal shipping transfer nodes, respectively. Drayage, i.e. truck transport to and from an ICT and the surrounding area, is a special component peculiar to an ICT logistics initializer 234.

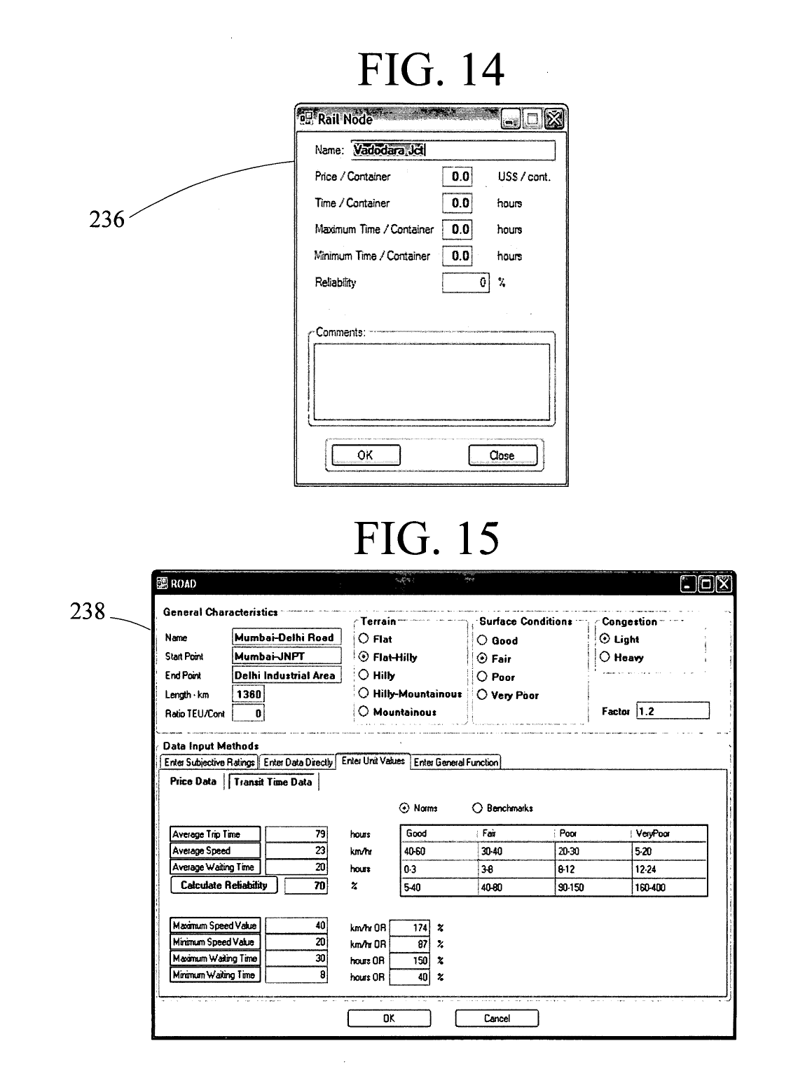

Turning to FIG. 14, the present invention preferably utilizes four types of transport transition nodes. The transport transition nodes are used primarily to separate road, rail, intercoastal waterways (IWW), or coastal links into more than one segment, where that is desirable (e.g., there are significant differences in price, time or reliability between two segments of a link). The transport transition node freight logistics initializer 236 accepts data values related to a change in freight transport performance: specifically a freight transport transit time and a freight transport price. More specifically, the freight transport transit time change and the freight transport price change are established by eliciting data related to the price per freight, time per freight, the maximum and minimum times per freight, and the reliability of the freight transport transit time. The transport transition node logistics initializer 236 of FIG. 14 is adapted to logistically initialize a rail transport transition node; the data values accepted by it are typical of the values that would be accepted by road, intercoastal waterway, and coastal transport transition nodes.

Reliability for the transport transition nodes is calculated from maximum and minimum times entered by the user. This number is the percent of the average time that is represented by the difference between the average and the maximum and minimum times on the average. Maximum and minimum times are estimated by the user to include 90% of the variation in time at the node.

As FIG. 15 shows, the transportation link logistics initializer 238 accepts data values related to a freight transport transit time and a freight transport price. More specifically, the transportation link logistic initializer accepts inputs concerning performance indicators (e.g. price, time and reliability) or qualitative performance rating (e.g. good, fair, poor or very poor) as well as the name of the link and indicators of its physical characteristics (e.g. length, terrain, etc). Each transportation link displayed represents a single transport pathway corresponding to a means for a freight to travel from one location to another. The primary transport pathways of the present invention include roads, railways, coastal waterways, and inland waterways.

The start point and end point of a transportation link are filled in automatically from the graphic model, which keeps track of the nodes to which the transportation link connects. The length is an important piece of information used to calculate total trip time and cost. The terrain surface and condition are used to determine a factor that relates norms to the specific condition on this link, and a factor is the ratio of the price for the specific conditions to a flat, good condition, road with light congestion. This factor can be used by the user to relate the unit values for the transportation link to norm values.

The road logistics transportation initializer 238 depicted in FIG. 15 form allows for four different methods of data input: qualitative data entry, quantitative data entry, unit values entry, and general function. There are also separate entries for price and time. FIG. 15 shows unit value entry for time data. The user enters average trip time and average waiting time along the transportation link; and the user enters upper and lower speed values and waiting time value, which represents reliability. It is recommended that the user use the idea of values that would include 90% of all transportation and waiting times to select these upper and lower values. From these data, the present invention may calculate average speed, and the percentage of the average value represented by upper and lower bounds. The present invention calculates the total link reliability when requested.

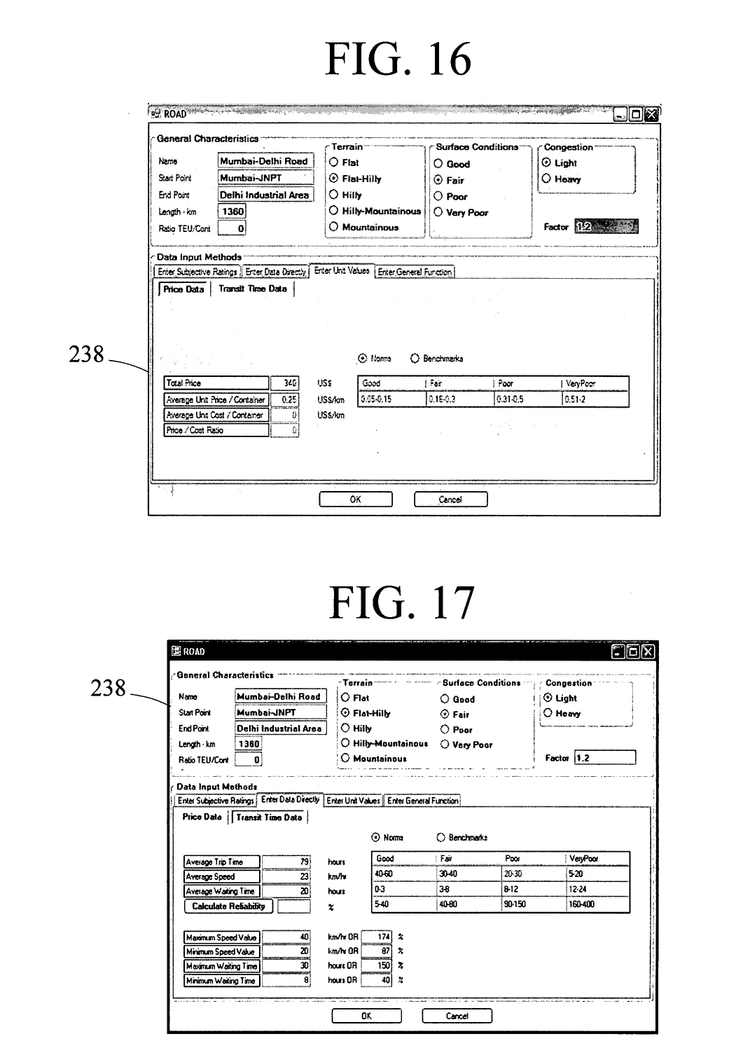

FIG. 16 shows the price data entry form for the road logistics transportation initializer 238. The user enters the average unit price per freight-km or the average unit cost and a price/cost ratio (if the price data is not known). The present invention calculates the total price and color codes the norm number that corresponds to the unit price.

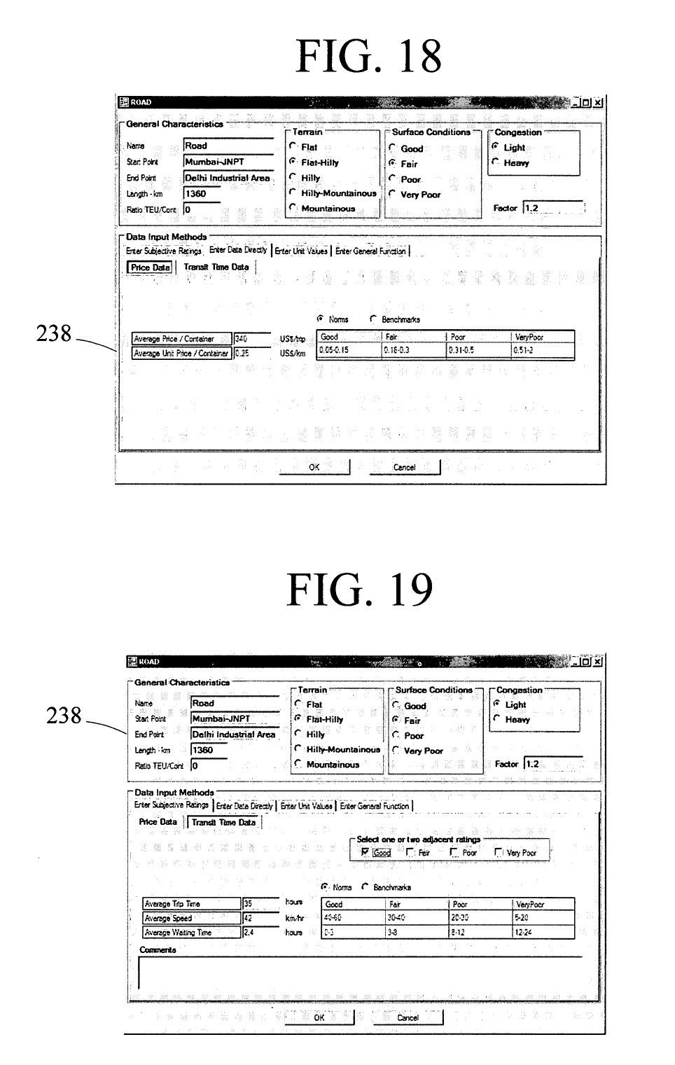

The road logistics initialization related to time factors is shown in FIG. 17 and the form for direct data entry for logistic initialization related to price is shown in FIG. 18. They are very similar to the unit value forms except that they accept different numbers and the present invention calculates the remaining values. In the transportation logistics initializations of FIG. 19, the rating of good was selected, and from that qualitative input, the present invention computed the average speed, waiting time, total transportation time, unit price, and total price.

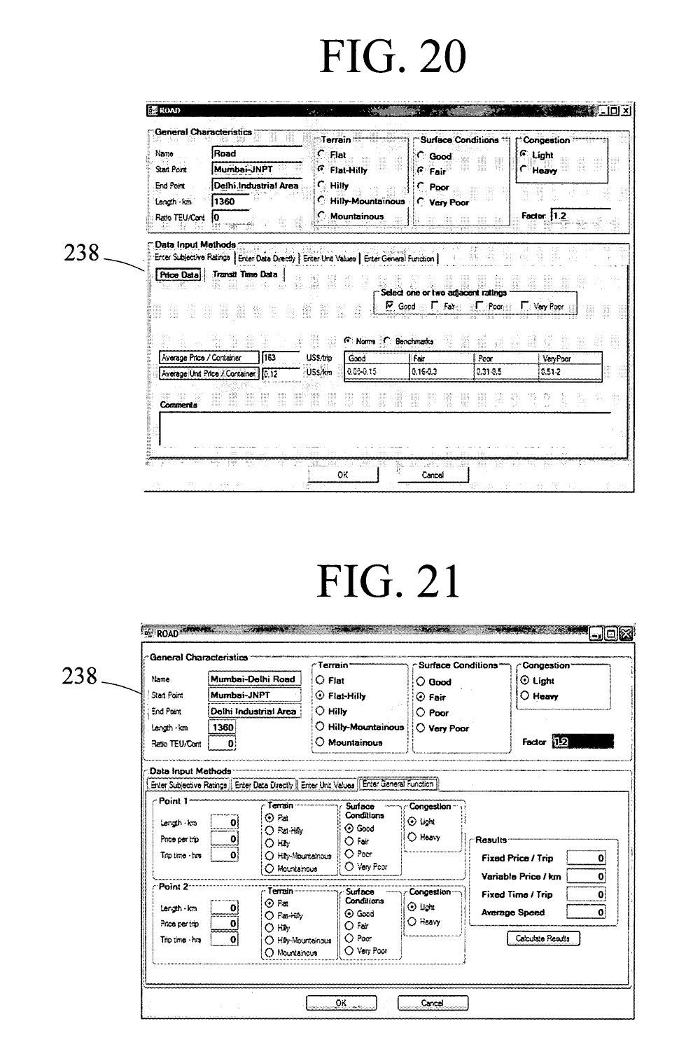

As FIG. 20 shows, for the general function input means a simple linear model of price and time is used (p=aP₁+P₀ or t=aT₁+T₀), where there is a variable coefficient and a fixed constant in each case. This general function is specified by taking two transportation links on the road network and noting their characteristics, as FIG. 21 exhibits. Using the factors for the two transportation links, the present invention then calculates the fixed and variable values for price and time for flat, good condition and light congestion and displays these values.

The calculation of the fixed and variable values takes into account the terrain, road surface and congestion factors for the different points and for the link being analyzed. This means that the cost and time for each point are adjusted (i.e. normalized) by a factor that reflects these three characteristics as part of the calculation. Then the calculated values are further adjusted by a factor that reflects the characteristics of the current transportation link. The factors are derived from the World Bank's HDM4 model.

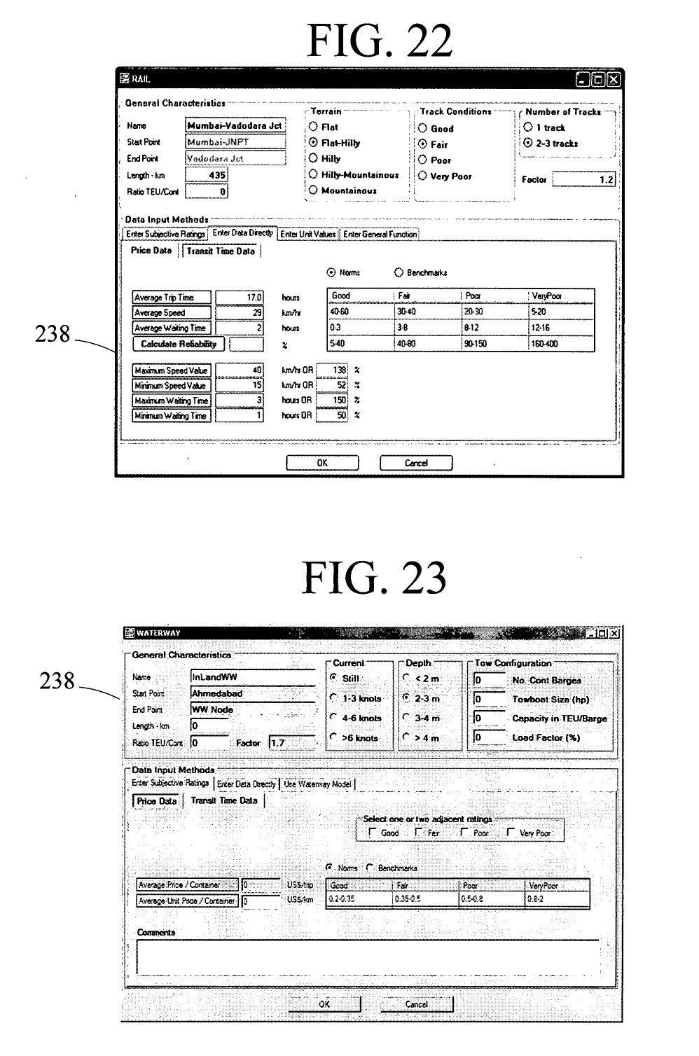

Turning now to FIG. 22, the rail transportation link 238 logistics initialization input process is very similar to the road transportation link logistics initialization process. The primary difference is in the transportation link characteristics.

The rail transportation link characteristics have the same terrain classification as road transportation links, but two additional preferred characteristics include track condition and number of tracks. These characteristics are used to look up a factor in a manner parallel to road transportation links. This factor is preferably displayed to the user. The price factor for rail as a function of terrain and condition is lower than for road, since rail pricing is not as market driven.

There are four methods for data input: qualitative, quantitative direct data entry, unit value entry and general function, which function similar to the road transportation links.

FIGS. 23-25 illustrate the inland waterway transportation link logistics initialization 238, which are treated in a manner similar to that for road transportation link and rail transportation link initializations, but the types of characteristics differ due to the use of towboats and barges in a river or canal.

The user enters general data, including the name of the waterway link, its length in kilometers, the ratio of TEU to freights on this link, the average current speed for this waterway, the minimum depth, and the typical tow configuration for tows traveling on the waterway transportation link.

The user may then enter one of three methods of data input. These include qualitative data entry, quantitative direct data entry, and data entry into the waterway model. The qualitative is the simplest and can be applied to the price data and to the transportation time data by selecting a rating category (e.g. good, fair, poor or very poor) or two adjacent categories. Then the present invention calculates the price, time, and reliability values using the values for the selected ratings. For the quantitative direct data entry option, the user enters data values directly, verifying that the selected data values correspond to the performance ratings and the channel depth that apply to this transportation link.

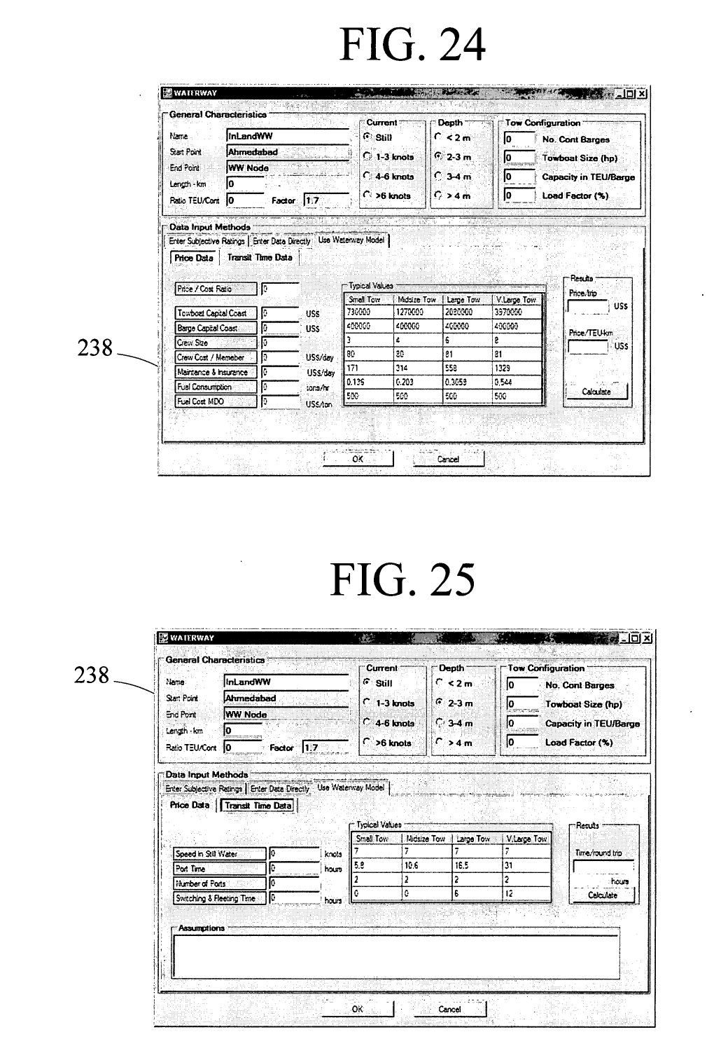

Embodiment of the present invention may feature more sophisticated modeling data inputs as displayed in FIGS. 24-25. The waterway model requires the user to input more data than the previous transportation link initialization entries. The data inputs, shown in the price and time forms, assist the present invention in calculating the transportation time and price per freight-km and per trip.

It is preferred that data guides for the user are made available in the tables opposite any input boxes. These represent typical data based on the standards data base, but they are only a guide. Once the user has entered the data and calculated the outputs from the model, the present invention will transfer the average price and transportation times for logistics chains and subchains to a model database so that the model database values can be compared with freight transport performance values derived from the standards database. The user may view these data along with the norms in a graphics format, if desired. It is preferred that the user has the option to enter cost data instead of price data, along with a ratio of price to cost as offered by the present invention to determine price. This is normally cost plus a profit percentage (e.g., 1.20).

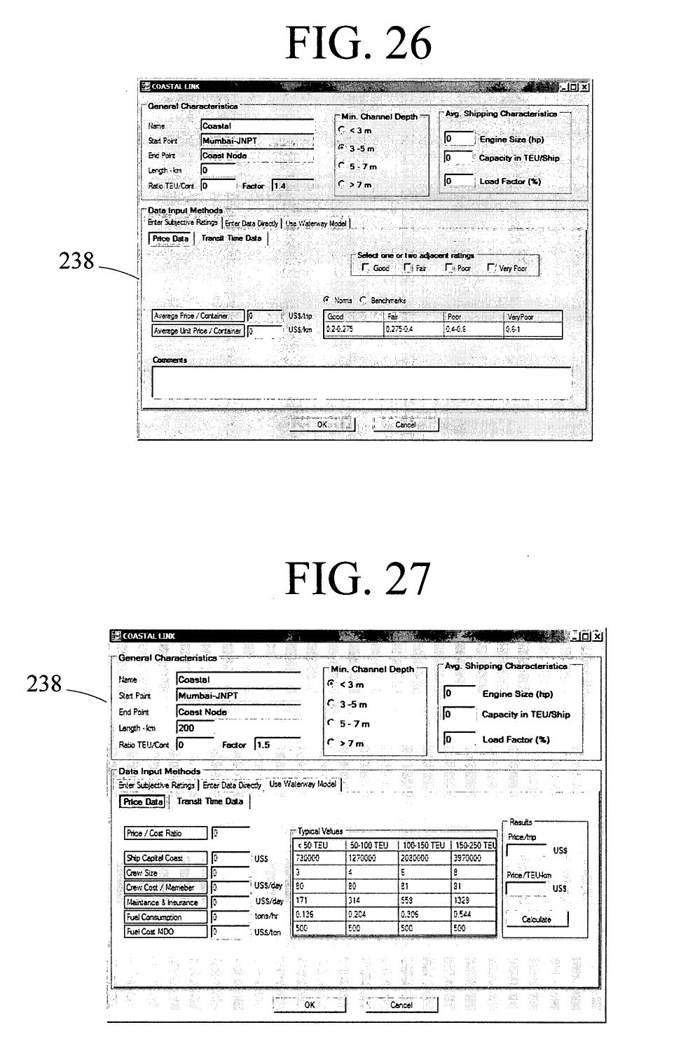

Turning now to FIG. 26, the coastal link logistics initializer 238 of the present invention are very similar to the waterway logistics initializations, but the types of characteristics are, of course, different due to the use of ships along coastal routes and in coastal port channels.

The user inputs general data, including the name of the coastal link, its length in kilometers, the ratio of TEU to freights on this link, the minimum channel depth along this link (generally in a coastal port), and the average shipping characteristics for ships traveling along the link. The user further inputs data via one of three methods. These are qualitative data entry, quantitative direct data entry and data entry into the waterway model. The qualitative is the simplest and can be applied to the price data and to the transportation time data by selecting a rating category (e.g. good, fair, poor or very poor) or two adjacent categories. Then the present invention calculates the price, time and reliability values using the norm values for the selected ratings.

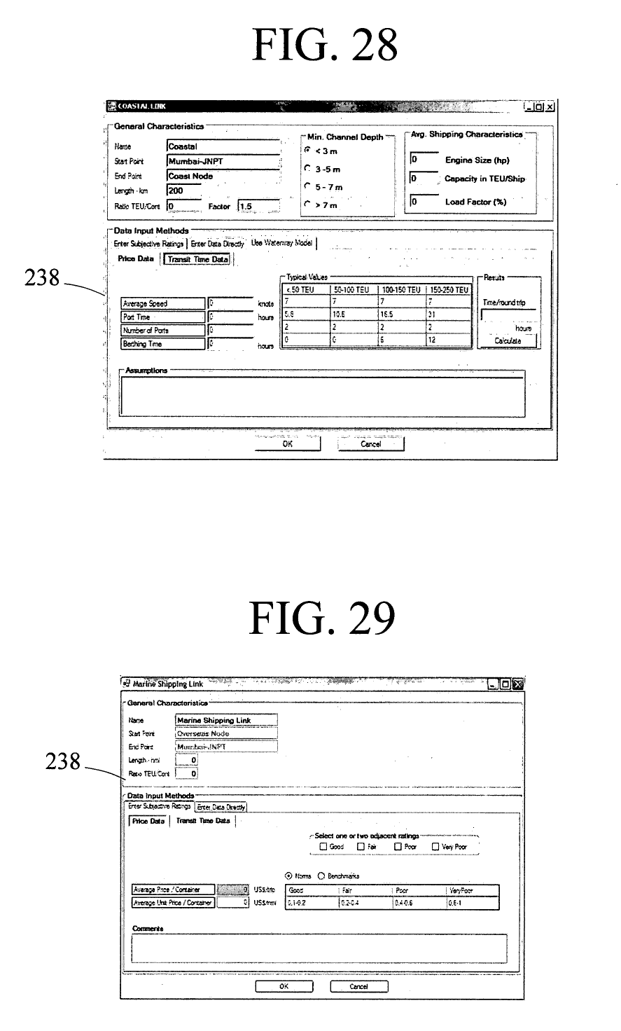

Embodiment of the present invention may feature more sophisticated modeling logistics initializers 238 as displayed in FIGS. 27-28. These shipping model logistic initializers require the user to input more data than the previous methods. The user enters data relating to price and time forms, and the present invention calculates the transportation time and price per freight-km and per trip.

After a user that has entered the data and calculated the outputs from the model, the present invention will transfer the average price and transportation times to the database so they can be compared with norms from the standards database for these data. The user may then view these data along with the norms, if desired.

Turning now to FIG. 29, the marine shipping transportation link initializer 238 of the present invention is very similar to the coastal shipping link logistics initializations, but there are no special characteristics for this kind of transportation link. It is preferred that the data inputs focus on price, time and reliability only. The user inputs general data, which preferably consists of only the length of the link in kilometers and a transport shipment size indicator, such as TEUs per container, on this link. As it is preferred that the overseas node be created in the seaport node initialization, it is further preferred that the name of the link was entered at that time.

A user then has the choice of two methods of data input. These are qualitative data entry and quantitative direct data entry. The qualitative is the simplest and can be applied to the price data and to the transportation time data by selecting a rating category (good, fair, poor or very poor) or two adjacent categories. Then the present invention calculates the price, time and reliability values using the norm values for the selected ratings.

Returning to FIG. 1A, once the logistic initializations are complete and the nodes and links are placed on the canvas, the present invention may calculate 108 freight logistic performance efficiencies, which are summaries of all key data values by either a subchain or for the total chain. The present invention may additionally calculate an overall logistics efficiency score ranging between two numerical values.

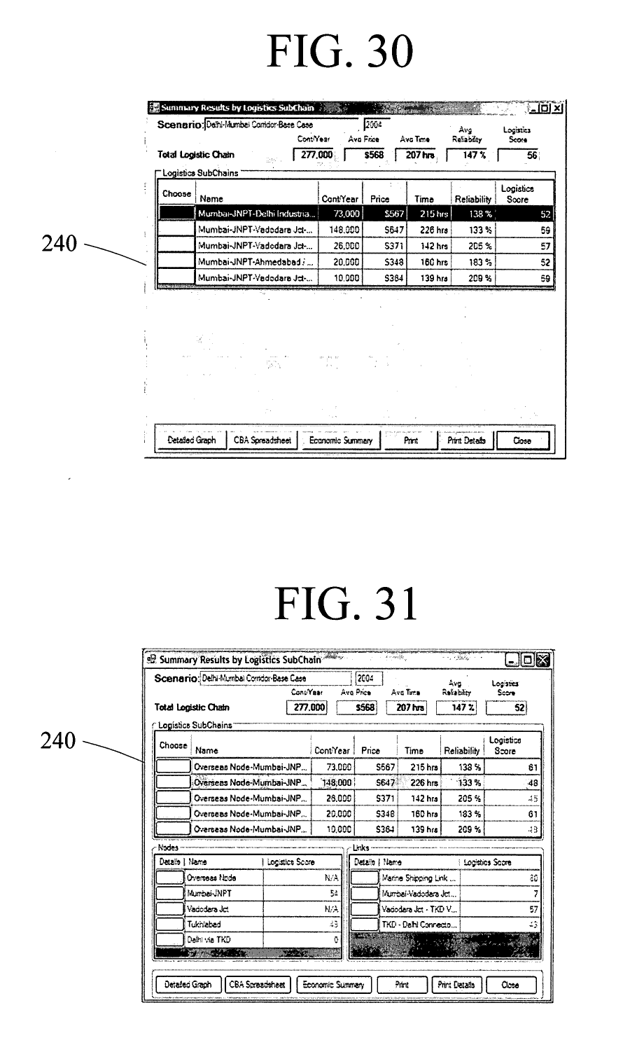

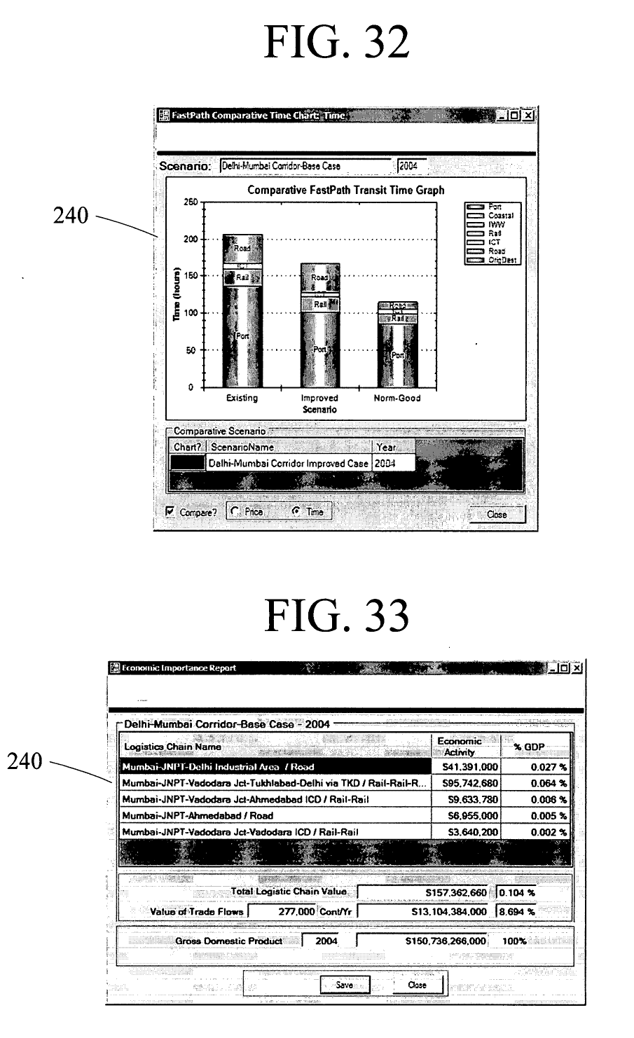

As FIG. 2 and the screenshot in FIG. 30 show the output 124 of results from logistics chain performance 240 derived from a logistics model. These values represent a total for all freight volumes in the scenario and weighted averages of price, time, reliability, and overall logistics efficiency score over all the subchains. The logistics score is preferably color coded to denote the rating it implies (in the example, blue means a fair rating). Each subchain is listed along with its performance results. Additional performance results 240 are shown in FIG. 31; the nodes in the subchain are shown on the bottom left and the links are on the bottom right. There is an overall logistics efficiency score shown for each. This is preferably color coded to reflect the rating that this implies (e.g., the rail node has a good rating in green). Freight logistics performance results may be displayed by any means natural to display information. As FIG. 32 shows, the performance results may be displayed by bar graph subdivided into discrete transportation link categories.

Summary output tables may also show the total logistics chain statistics in terms of total freight moved through the chain, the average price to the shipper per freight, the average time in transportation (i.e. from port entry to destination or from hinterland origin to port departure) and a composite reliability (i.e. variation in transportation time). The present invention sums up the performance measures for all the components of each subchain and computes a weighted average to get the total chain performance. This is a significant aid to the user who would have to do this summary by hand or by spreadsheet.

The summary may also compute a total logistics score for each subchain and for the chain as a whole. This logistics score relates actual performance to ideal performance according to international norms. It is preferred that the results of the logistics score are color coded to correlate to performance. This color coding is also applied to the logistics scores for each link and node in the logistics chain as shown in a detailed summary table. The user can then focus on which part of the logistics chain is performing poorly and go to that component for a more detailed look at its performance. These results are available for each transportation link and node in the graphic model screen. So the user can point and click to view them, as long as the performance indicators have been calculated for that scenario.

Additional forms of performance result outputs may include cost-benefit analysis that calls on the database developed by the user to insert information from two scenario models. The cost-benefit calculation compares the performance data from the existing scenario model and the performance data from an alternative, potentially theoretical, scenario model. It shows the difference in costs and time for a specific year and provides a simplified calculation for a user-specified period of analysis, if desired. This includes inputting investment cost data and a detailed input for the yearly costs and benefits, which are calculated automatically based on the user's assumptions.

An additional form of performance output includes a table of economic importance as shown in FIG. 2 and FIG. 33. This table shows the size of the trade flows in the logistics chain in dollar terms and compares this to GDP. It also calculates 114 the amount spent by logistics chain users to ship total freight volume through the chain. The total economic importance value is the sum of the trade value and the freight logistics value. The user need enter only the amount of GDP and the year of this statistic; the present invention calculates the rest of the numbers in the table.

The present invention is adapted to retain scenario models previously created in order to select 122 and compare 120 existing scenario models to proposed, theoretical scenario models. The theoretical scenario model is built in the same manner as an existing scenario model, but relies heavily on benchmark or norm data values. The comparison may compare any of the freight transport performance outputs 120 between the existing scenario model, and one or more theoretical scenario models.

Although the present invention has been discussed in terms of freight with specific reference to container calculations, prompts, outputs, and measurement; the present invention applies to all types of freight. In order to adapt the present invention from container to more general freight shipments, a user should perform the following actions: show units for input and output values as tonnes rather than containers or tonne-km rather than cont-km; change value per container to value per tonne in the scenario input screen and change the formula for calculating total value in the economic importance table; add a “handling type” input data element that would specify shipment size, where appropriate (e.g. bulk, pallet, tank, etc.) and capacity along with average load; and expand the data in the benchmark and norm tables to relate to value per tonne rather than value per container and to loading and unloading times per tonne. Furthermore, the benchmark and norm tables may have to be reorganized in terms of containers, solid bulk, liquid bulk, palletized or general cargo and there may be a need to have some form of input for loading technologies (e.g. conveyor belt, pump, manual, etc.).

Although the present invention has been described in considerable detail with reference to certain preferred versions thereof, particularly container transport versions; other versions would be readily apparent to those of ordinary skill in the art. Therefore, the spirit and scope of the appended claims should not be limited to the description of the preferred versions contained herein.

What is claimed is:

1. A process for creating an interactive, visual, user-defined freight transport supply model, said process comprising:
establishing a freight logistics chain by logistically initializing both a seaport node and a hinterland node on a canvas;
subdividing said freight logistics chain with a logistically initialized transport transition node on said canvas into a freight logistics subchain;
interconnecting at least two of said logistically initialized nodes with a logistically initialized transportation link representing a single transport pathway; and
calculating a freight transport performance value between at least two of said nodes based on all of said logistical initializations between said at least two nodes.

2. The process of claim 1 further comprising the step of displaying a toolbar having a propagating transport transition node from which the user may select said transport transition node and a propagating transportation link from which the user may select said transportation link.

3. The process of claim 1 further comprising the step of supplementing at least one of said logistic initializations with a freight transport performance value from a standards database.

4. The process of claim 3 wherein said supplementing step includes the steps of: querying a user as to a qualitative level of freight transport proficiency; and supplementing at least one of said economic initializations with at least one of said freight transport performance values correlating to said freight transport proficiency level from said standards database.

5. The process of claim 1 further comprising the step of comparing said freight transport performance value based on said logistical initializations to a theoretical freight transport performance value based on data values from said standards database.

6. Freight logistics transport modeling software system comprising:
a canvas;
a seaport node logistics initializer for accepting data values related to freight transport performance and displaying a seaport node on said canvas;
a hinterland node logistics initializer for accepting data values related to freight transport performance and displaying a hinterland node on said canvas;
a transportation link logistics initializer for accepting data related to a freight transport transit time and a freight transport price, and displaying a transportation link corresponding to a single transport pathway between two nodes on said canvas;
a transport transition node logistics initializer for altering data related to said freight transport transit time and said freight transport price; and displaying a transportation transition node in an adjustable location on said canvas;
a standards database with multiple levels of standards data corresponding to freight transport proficiency and adapted to be accessed by at least one of said initializers; and
a freight logistics efficiency calculator adapted to formulate a freight transport performance value between at least two of said nodes based on all of said logistical initializations between said at least two nodes.

7. The system of claim 6 wherein said freight logistics efficiency calculator is further adapted to compare said freight transport performance value to a theoretical freight transport performance value formulated from data values referenced from said standards data.

8. The system of claim 7 wherein said standards database include a benchmark sub-database and norms sub-database.

9. The system of claim 6 further comprising a toolbar, proximate to said canvas, with a transportation link propagator and a transportation transition node propagator.

10. The system of claim 9 wherein said toolbar further comprises a hinterland node propagator.

11. A geographic information systems aided process for creating an interactive, visual, user-defined freight transport supply model, said process comprising:
displaying a representation of a seaport, said seaport representation adapted to create a seaport node and a representation of a hinterland destination, said hinterland representation adapted to create a hinterland node;
retrieving geographic coordinate data related to a location of said seaport and said hinterland destination;
portraying on a canvas a spatially accurate model of said seaport node and said hinterland node;
logistically initializing said seaport node and said hinterland node with data values related to freight transport performance; and
interconnecting at least two of said logistically initialized nodes with a logistically initialized transportation link representing a single transport pathway.

12. The process of claim 11 further comprising subdividing at least one of said transportation links with a logistically initialized transport transition node on said canvas.

13. The process of claim 12 further comprising calculating a freight transport performance value between at least two of said nodes based on all of said logistical initializations between said at least two nodes.

14. The process of claim 13 further comprising the step of displaying a toolbar having a propagating transport transition node from which the user may select said transport transition node and a propagating transportation link from which the user may select said transportation link.

15. The process of claim 14 further comprising the step of comparing said freight transport performance value based on said logistical initializations to a theoretical freight transport performance value based on data values from said standards database.

16. The process of claim 11 further comprising the step of supplementing at least one of said logistic initializations with a freight transport performance value from a standards database.

17. The process of claim 16 wherein said supplementing step includes the steps of:
querying a user as to a qualitative level of freight transport proficiency; and supplementing at least one of said economic initializations with at least one of said freight transport performance values correlating to said freight transport proficiency level from said standards database.
